(19) United States
(12) Patent Application Publication
(10) Pub. No.: US 2015/0057949 A1
(43) Pub. Date: Feb. 26, 2015

(54) Event Detection For Back-Scattering Interferometry

(71) Applicant: Molecular Sensing, Inc., Nashville, TN (US)

(72) Inventors: Scot R. Weinberger, Montara, CA (US); William E. Rich, Nashville, TN (US); Stephen Dotson, Nashville, TN (US); Kirk C. Odencrantz, Boise, ID (US); Fei Shen, San Jose, CA (US); Richard Isaacs, Nashville, TN (US)

(21) Appl. No.: 14/389,504

(22) PCT Filed: Mar. 15, 2013
(86) PCT No.: PCT/US2013/032308

§ 371 Date: Sep. 30, 2014

Related U.S. Application Data
(60) Provisional application No. 61/635,298, filed on Apr. 19, 2012.

(51) Int. Cl. G01N 21/45; G01J 9/02

(52) U.S. Cl. CPC G01N 21/45; G01J 9/02
USPC 702/32

(57) ABSTRACT

Methods and systems for improved chemical event detection from back scattering interferometry fringe data provide sensitive detection of a chemical event by more selectively analyzing fringe shift data.

### CROSS REFERENCE TO RELATED APPLICATIONS

This application claims priority from provisional patent application 61/635,298 filed Apr. 19, 2012 incorporated herein by reference. This application may be related to other patent applications and issued patents assigned to the assignee indicated above or otherwise related to the invention. These applications and issued patents are incorporated herein by reference to the extent allowed under applicable law. These applications and patents include: U.S. Pat. No. 8,120,777 Temperature-stable interferometer; U.S. Pat. No. 7,835,013, Interferometric detection system and method; U.S. Pat. No. 6,381,025, Interferometric detection system and method; U.S. Pat. No. 6,809,828, Universal detector for biological and chemical separations or assays using plastic microfluidic devices, and U.S. Pat. No. 5,325,170, Laser-based refractive index detector using backscatter; and other patents and applications referenced herein.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### FIELD OF THE INVENTION

The present invention relates to analysis of interferometric data and related systems and methods. As an exemplary embodiment, the invention relates to systems and methods that involve using interferometry data to analyze chemical events and/or other physical or chemical characteristics of a sample or volume. Methods and devices according to specific embodiments of the invention may involve information or logical processing circuitry or systems configured to operate as described herein. Methods and devices according to specific embodiments of the invention may also involve logic instructions or data recorded on a tangible media according to specific embodiments of the invention that can configure an information device to operate as described herein.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

Interferometric detection systems have been used over the course of the last several years as a means to probe solid substrates as well as a means to study liquid systems or solutions. A particular subset of interferometry technology is Back-scattering interferometry (BSI). BSI is a method useful for detecting interactions between molecules in a sample. A version of the method was described in U.S. Pat. No. 5,325,170 (Bornhop et al., Jun. 28, 1994). More recently, BSI has been used to study chemical events (see U.S. Pat. No. 8,120,777). Chemical events are defined as unimolecular or multi-molecular phenomenon which include but are not limited to bi-molecular or multi-molecular binding (molecular complex formation), unimolecular aggregation (where the same species aggregates with itself), as well as unimolecular changes in molecular conformation (changes in secondary, tertiary, and/or quaternary structure). It has been previously understood that chemical events involving molecules in the fluid, such as ligand-receptor interactions, change the refractive index of the fluid and result in a shift in the location of the fringe pattern. U.S. Pat. No. 6,381,025 (Bornhop et al., Apr. 30, 2002) describes a method for performing back-scattering interferometry in which a channel is disposed in a micro-fabricated substrate. U.S. Pat. No. 6,809,828 (Bornhop et al., Oct. 26, 2004) describes a chip for back-scattering interferometry in which the substrate has a channel taking the form of a rectangle. U.S. Pat. No. 7,130,060 (Bornhop et al., Oct. 31, 2005) describes a method for determining absolute refractive index using back-scattering interferometry in which light is directed at a capillary tube and refractive index is determined as a function of the angle at which there is a marked change in intensity. Bornhop et al., Science, 317:1732, Sep. 21, 2007, describes free-solution, label-free molecular interactions investigated by back-scattering interferometry. U.S. Pat. No. 8,120,777 (Weinberger et al., Jul. 23, 2009) describes an interferometer for detecting analyte in a microfluidic chip that maintains a stable temperature at the chip and in the optical path of the interferometer. According to specific embodiments, the present invention can be used in or incorporate aspects of one or more of the systems described in the above applications consistent with the teachings provided herein.

While the above references have disclosed many advances related to BSI systems and methods, there remain a number of instances where the BSI analysis and detection of the binding or chemical event signal is not as sensitive as would be desired to detect some physical or chemical events or properties of interest.

Furthermore, there are a number of instances where it is desirable to improve the quantitative analysis that can be performed by BSI or similar systems. BSI systems can generally be used to quantify the amount of a molecule within a solution. In this case, a quantification calibration curve is constructed by measuring the refractive index signal for a dilution series of samples, with known concentrations of analyte. Under these conditions, the BSI signal is known to be proportional to analyte concentration, and as such, the resulting calibration curve can be applied to determine the quantity of the same analyte in an unknown solution of identical solvent composition. However, similar limitations to those limiting the precision of the data gathered and analysis components of existing systems, lead to less sensitive or less accurate quantification results than would be desired.

### SUMMARY

The present invention is directed to systems and methods for analysis of physical and chemical systems using interferometry to determine a tangible result. One application is improved detection of binding events or other chemical or physical characterizations of samples using optical interferometry, and as an exemplary system, using a BSI system or data collected by such a system and reporting of that detection to a user or external system.

While the detection and analysis approaches discussed in above referenced applications are effective in many situations, in some situations these approaches miss binding or chemical event signal that is present in the fringe pattern or detect the signal at poor detection levels, which can report false negative results.

Previous efforts to improve detectability have generally relied upon either (1) slight modifications of the optical train that alter the alignment of incident light with the detection channel, and/or (2) varying the fringe number or fringe order being imaged by the capture device (e.g., a camera) that is then analyzed with conventional signal processing or analysis methods. According to specific embodiments, the present invention uses one or more new signal analysis approaches to examine the fringe data in more individualized ways and using more than one basic signal analysis methods. Thus, in contrast to the previous approach of altering optical alignment or fringe monitoring, the present invention in some embodiments is directed toward applying unique signal processing operations to imaged fringes to lock in and amplify the detection of an event or binding signal. In other embodiments the invention is directed toward evaluating a number of signal processing operations, which may include known and/or new signal processing operations, to determine an operation suitable for detecting a chemical event or binding signal in a given system or at a given time. In specific embodiments, the present invention analyzes portions of the fringe data more independently and with a greater variety of signal processing operations thereby allowing for the detection of binding energy or event signal that may be distributed to many fringes generated in a BSI system.

In the art of signal processing, terms such as signal processing, signal analysis, signal processing algorithms, signal processing operations, and signal analysis algorithms do not generally have distinct definitions and are often used interchangeably. In this discussion, the terms should be considered interchangeable unless the context of the use in particular instances suggests otherwise. In general, the term signal processing operation is used herein to indicate one of a group of different signal processing operations, such as Fourier Transform, Cross Correlations, or modifications as described herein. In further embodiments, the invention performs different signal processing operations on different subportions of the data and evaluates those operations to determine which operations and which portions or subportions of the data are selected to detect an event. Evaluation criteria can include any statistical or signal processing criteria, such as signal/noise ration (S/N) or R². Evaluation criteria can also include any criteria based on “first principles” of chemical event or chemical reaction modeling, such as K_{d} or other expected dynamics or characteristics of a system being analyzed.

Thus, in various aspects, the present invention evaluates sub-portions of fringe data and selects subportions of fringe data that provide better detection and/or quantification of chemical events or binding events of interest. Subportions of fringe data, for example, can include one or more individual fringes or parts of fringes, generally selected by examining the results of particular analysis methods on that data. As described below, various signal processing operations are performed on individual fringes from at least 2 captured fringe patterns (e.g., fringes A, B, C, and D) and on combinations of fringes (e.g., A+B, A+C, A+D, A+B+D, etc.) and these operations are evaluated to determine the operation and fringe subportions that provide better detection (which can also be referred to as providing a stronger or more sensitive event signal). Subportions of fringe data, for example, can also include one or more spatial frequencies or a range of spatial frequencies of the fringe data. Thus, in specific embodiments, a chemical event may be detected by looking for a phase shift not only in a dominant spatial frequency (e.g., 5) but also by evaluating or including phase shift in one or more additional, non-dominant spatial frequencies (e.g., 3 plus 6) including non-integer frequencies. Again, as described above, these individual frequencies or portions of frequencies are evaluated by performing one or more signal processing operations on different subportions and evaluating those operations against expected curves for a reaction or chemical event of interest. Sub-portions of fringe data can also include subsets of data as defined by the pixel capture device, for example particular captured bits or sets of bits, such as vertical or horizontal slices of the captured image data.

Thus, in further embodiments, in addition to comparing individual fringes between fringe patterns, as well as their spatial frequencies for optimized binding signal, the invention can evaluate the binding signal using discrete sub-portions of the imaged fringes that are captured as numerical values by vertically and horizontally arrayed pixels that image the entire fringe, in essence taking corresponding vertical and horizontal slices of the fringe data.

While some previous work has been directed at determining which of the fringe data are most useful for detecting an overall change in RI from the sample or an overall fringe shift (e.g. a bulk measurement of the entire sample), according to specific embodiments, the present invention is involved with one or more systems and methods, that examine subportions of the fringe patterns independently in order to detect fringe shift in just those subportions of the data where the shift is due to an event in the sample (such as a binding event, protein folding event, etc.). To state in other words, the present invention according to specific embodiments is directed to detecting and/or discriminating the chemical event signal (or binding signal) from the data captured in a BSI or similar system by one or more of (1) considering more of the total interferometry data and (2) allowing for a greater selectivity as to which parts of that data are used to detect the signal and (3) employing two or more different signal analysis methods to detect a change in fringe pattern that is due to an event.

Thus, in various aspects, the present invention uses the discovery that the inter-molecular binding or event signal does not necessarily manifest itself as simple changes in overall refractive index of the probed solution but is selectively present in certain frequency domains or other subportions of the imaged fringe pattern. According to specific embodiments of the invention, the event signal component (of the overall refractive index signal) generally reflects changes in mean polarizability of the probe volume that arise from changes in one or more of the chemical complex's multipole moment, electronic configuration, or hydration state.

Thus, the present invention, according to specific embodiments, involves one or more new signal detection and/or data analysis approaches for BSI measurements that enables the extraction of an event signal from overall refractive index signal, resulting in enhanced detection for binding events as subsequently described herein.

Depending upon the nature of the molecular interaction, binding species can be equally distributed within the probe volume or more greatly concentrated upon the walls of the vessel that defines the probed volume. The latter is particularly true for heterogeneous assays, as heterogeneous assays rely upon the tethering of binding species to the vessel wall. However, for homogeneous assays, it is known that certain biomolecules, based upon their isoelectric point (pI) hydropathic index and secondary to tertiary structure can preferentially concentrate upon or in close proximity to vessel walls. As such, homogeneous assays can somewhat behave like heterogeneous assays in terms of species distribution.

According to specific embodiments of the invention, ray tracing experiments indicate that fringes generated from the back-scattering interferometer take their origin from different interfaces and regions of the detection vessel. Consequently, some fringes contain information predominantly from the vessel surfaces, while others contain more information from the bulk. Moreover, fringe information content is also effected by the geometry of the probed region, as cylindrical geometries provide a fringe-signal distribution distinct from that of hemi-cylindrical or other commonly employed geometries for BSI analysis. According to specific embodiments, the present invention analyses the interferometry data by detecting energy of the binding signal that is preferentially found within those fringes whose interference patterns arise from the probed region that contains the majority of the binding species. According to specific embodiments, the invention analyses fringe patterns to determine fringes in which the binding energy is preferentially found.

Moreover, the present invention does not require an a priori prediction of those fringes or portions of the fringe pattern that are most fruitful to detect binding signal. According to specific embodiments, the present invention addresses this by performing one or more different analysis methods on different portions of a fringe pattern and evaluating different portions of the fringe pattern for changes that are indicative of the chemical event of interest and then evaluating those analysis methods to determine which methods and which data are most effectively used to determine binding signal. According to specific embodiments, this analysis can be done during configuration of the system during manufacture or during calibration of the system by a user, or during operation of the system on a per experiment basis.

In the present discussion, the term ‘binding event” or “chemical event” or “event” is used broadly to refer to any chemical or biological change in the sample, excluding simple changes in unimolecular concentration of a sample, that can be detected, even where that change might not generally be termed a binding event. For example, whether or not proteins fold correctly or are caused to unfold as a result of certain conditions or added compounds should be understood as a ‘binding event” or “chemical event” or “event” in the present discussion.

Further Embodiments and Software Implementations

Various embodiments of the present invention provide methods and/or systems for interferometric analysis that can be implemented on a general purpose or special purpose information handling appliance, e.g., a computer, smart-phone, or information enabled laboratory, diagnostic, clinical, manufacturing, or consumer systems, using any suitable programming language such as Java, C++, C, Pascal, Fortran, PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers’ specific goals and subgoals, such as compliance with system-related and/or business-related constraints, which will vary from one implementation to another. Moreover, it will be appreciated that such a development effort might be complex and time-consuming, but would be a routine undertaking of software engineering for those of ordinary skill having the benefit of this disclosure.

Any of the methods described herein can according to specific embodiments further comprise any one or more of the following: providing a substrate having a compartment formed therein for reception of a liquid and injecting the liquid into the compartment; directing a coherent light beam onto the substrate such that the light beam is incident on the compartment containing the liquid to generate backscattered light; and detecting the backscattered light, wherein the backscattered light comprises a fringe pattern whose position may shift in response to changes in the refractive index of the liquid. Detection is carried out by a photo detector having a pixel resolution and positional shifts may be identified in sub-pixel resolution. The coherent light beam can arise from a laser, for example with a beam diameter of 2 mm or less. The coherent light beam can arise from a diode laser with a beam diameter of 2 mm or less. The temperature of a liquid can be measured from the change in refractive index of the liquid. The composition of a liquid can be measured from the change in refractive index of the liquid. The flow-rate of a liquid in a stream can be measured from the change in refractive index of the fluid.

A first and second biochemical species and whether the first and second biochemical species interact with one another can be monitored by monitoring the change in refractive index of the liquid. In some instances, the first and second biochemical species are selected from the group comprising complimentary strands of DNA, DNA-RNA compliments, DNA-protein pairs, RNA-protein pairs, complimentary proteins, drug molecule-receptor pairs, ligand-receptor pairs, antibody-antigen pairs, and lectin-carbohydrate pairs. Methods herein can provide monitoring of whether a ligand in a liquid binds with one or more receptors by monitoring the change in refractive index of the liquid. In another embodiment, a method can comprise analyzing a label-free hybridization reaction in a liquid by analyzing the change in refractive index of the liquid. Analyzing a chemical or enzymatic reaction between two or more molecules can be completed by monitoring the change in refractive index of a liquid. In an embodiment, a method provides analyzing a structural or conformational change of a molecule by monitoring the change in refractive index of a liquid. In an embodiment, a method provides a means of quantitating or quantifying the amount of a target compound by monitoring the change in refractive index of a liquid that contains the target compound and its binding cognate.

In an aspect, this invention provides computer readable tangible medium comprising computer executable code that: (i) accesses from computer memory first data the fringe pattern generated at a first time and second data about the fringe pattern generated at a second time; (ii) performs multiple analyses of various portions of the fringe shift data and selects an analysis that provides the best detection.

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and allowable equivalents of those claims. Thus, in addition to descriptions of the present invention in further detail, it is to be understood that the invention is not limited to the particular embodiments described, as such may, of course, vary. It is also to be understood that the terminology used herein is for describing particular embodiments only, and is not intended to be limiting.

Furthermore, it is well known in the art that devices, systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention. Where a specific numerical value is mentioned herein, it should be considered that the value may be increased or decreased by up to and including 20%, while still staying within the teachings of the present application, unless some different range is specifically mentioned. Where a specified logical sense is used, the opposite logical sense is also intended to be encompassed.

Unless defined otherwise, all technical and scientific terms used herein have the same meaning as commonly understood by one of ordinary skill in the art to which this invention belongs. Any methods and materials similar or equivalent to those described herein can also be used in the practice or testing of the present invention though a limited number of the exemplary methods and materials are described herein.

As used herein and in the appended claims, the singular forms “a”, “an”, and “the” include the plural unless the context clearly dictates otherwise. Thus, for example, reference to “a device” includes a combination of two or more such devices, and the like. Likewise, use of the plural to describe elements of a system or method of the invention shall not be construed to require more than a single instance unless the context dictates otherwise or as specifically provided in the attached claims.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided might be different from the actual publication dates, which may need to be independently confirmed. Thus, all references, publications, patents, and patent applications cited herein are hereby incorporated by reference in their entirety for all purposes.

### BRIEF DESCRIPTION OF THE DRAWINGS

The file of this patent contains a least one drawing executed in color. Copies of this patent with color drawings will be provided by the United States Patent and Trademark Office upon request and payment of the necessary fee.

FIG. 1 illustrates an example of a BSI fringe pattern captured on a 1-dimensenional 3000 pixel CCD (e.g., in this example showing five complete peaks and 2 partial peaks in 2-dimensions) for example of one refraction at one time according to specific embodiments of the invention.

FIG. 2a-c illustrates an example of a fringe pattern as captured on using a CCD camera showing a larger number of fringes (e.g., >20) than are typically analyzed but that are available for detection of binding signal according to specific embodiments of the invention. The different colors in each figure illustrate different captures from a CCD camera or capture device that is moved to capture a larger part of the fringe. A-C show fringes captured from different samples, e.g. at different concentrations expected to provide different RI.

FIG. 3 illustrates a flowchart showing an example cross correlation operation according to specific embodiments of the invention.

FIG. 4 illustrates a flowchart showing an example sliding window FT operation according to specific embodiments of the invention.

FIG. 5 illustrates a flowchart showing an example of performing a forward FT and reverse FT operation to function as a notch filter according to specific embodiments of the invention.

FIG. 6 illustrates an example of a graph of frequency vs. magnitude and frequency vs. phase shift according to specific embodiments of the invention.

FIG. 7 illustrates an example of CAII vs. DNSA assay result with CAII concentration of 1 nM (a) from original fringe file (b) from filtered fringe file according to specific embodiments of the invention.

FIG. 8 illustrates an example of CAII vs. DNSA assay result with CAII concentration of 1 nM.

FIG. 9 is an example of a computer enhanced image of two fringes captured by a 2-dimensional CCD array (and providing 3-dimensions of data, with color indicating intensity) as generated by a fringe pattern arising from the binding buffer for an acetylcholinesterase assay used as an example system to illustrate aspects according to specific embodiments of the invention. This data may be vertically integrated to provide 2-dimensional data in one or more of the methods described herein.

FIG. 10 is a graph of the dominant spatial frequency mode for the example fringe pattern shown in FIG. 9, which in this example is spatial frequency two.

FIG. 11 illustrates a graph showing an example of a minor frequency mode for the same example, which in this example is spatial frequency three.

FIG. 12 is a graph showing example of binding curves generated for an assay of acetylcholinesterase-propidium iodide binding as monitored using FT analysis of the dominant and minor frequency modes noted in FIG. 9 and FIG. 10 respectively, as well as a cross-correlation function for the fringes depicted in FIG. 9, providing an example comparison for illustrating specific embodiments of the invention.

FIG. 13 illustrates an example of a difference plot of a time series (t₁ to t₅) of five captured BSI fringe patterns from five times with an increasing concentration of a substance known to cause an increasing refractive index and with each fringe pattern normalized by subtracting a first reference fringe pattern (e.g., Series 0) from it and normalized according to specific embodiments of the invention

FIG. 14 illustrates an example of Fourier transformation (FT) of the series 5 (t₅) data as shown in FIG. 13 from the highest concentration showing a dominant spatial frequency at 5, with smaller spatial frequency components at 4 and 6-8, according to specific embodiments of the invention.

FIG. 15 illustrates an example of linearly increasing amplitude of the different frequency components of the experimental data as shown in FIG. 13 according to specific embodiments of the invention.

FIG. 16 illustrates an example of the difference plot of the 2 millimolar (mM) fringe pattern minus the reference fringe pattern (Series 5-Series 0) as shown in FIG. 13. The red horizontal dash lines indicate the minima and maxima according to specific embodiments of the invention.

FIG. 17 illustrates an example showing the Series 5 data and the red horizontal dash lines show in FIG. 16 indicating the minima and maxima according to specific embodiments of the invention.

FIG. 18 illustrates the FIG. 16 and FIG. 17 data shown on the same graph according to specific embodiments of the invention.

FIG. 19 illustrates an example showing a difference at concentrations between 0 and 2 according to specific embodiments of the invention.

FIG. 20A-C are a series of graphs illustrating that a binding or event signal can be seen when switching from an (A) FT operation to a (B) CC operation and (C) showing that standard deviations of both FT and CC data are correlated suggesting that some sources of noise such as “injection error” are correlated and may be used as described herein for adjustment according to specific embodiments of the invention.

FIG. 21A-B illustrate a comparison between an FT signal assay and a CC assay and adjusted CC factors according to specific embodiments of the invention wherein the deviation from the mean for the average FT signals is multiplied by the average ratio of CC standard deviations to those from FT to arrive at a correction factor that is subtracted from the average CC signals. (B) Illustrates the affect of the correction on the best fit and error factors.

FIG. 22A-B illustrate a comparison between an FT signal assay and a CC assay and adjusted CC factors and CC individual factors according to specific embodiments of the invention wherein the deviation from the mean for the average FT signals is multiplied by the average ratio of CC standard deviations to those from FT to arrive at a correction factor that is subtracted from the average CC signals. (B) Illustrates the affect of the correction on the best fit and error factors.

FIG. 23A-D illustrate a comparison between a total binding model and a specific binding model according to specific embodiments of the invention with (A) showing a graph of the specific model, (B) showing a graph of the total model (C) showing a table with curve fit values for the specific model and (D) showing a table with curve fit values for the total model.

FIG. 24 illustrates a flowchart showing an example of performing a forward FT and reverse FT operation to function as a notch filter according to specific embodiments of the invention.

FIG. 25 A-B illustrates varying the start and stop locations of the captured fringe data and including partial peaks or patterns on the side according to specific embodiments. In A, FT analysis is applied to the window defined between minima 1 and 6. In B, FT analysis is applied to include the partial peaks that bound the previous FT window (H and T).

FIG. 26 is a graph illustrating an example shift analysis of captured fringe data at a number of different concentrations using entire fringes and analyzed by FT.

FIG. 27 is a graph illustrating an example shift analysis of the same captured fringe data at a number of different concentrations using different start and stop conditions and allowing for partial peaks to be included at the boundaries according to specific embodiments.

FIG. 28 illustrates an example of a signal versus concentration data captured in order to analyze a signal processing operation according to specific embodiments of the invention.

FIG. 29 illustrates an example of a signal versus time data for a given concentration captured in order to analyze a signal processing operation according to specific embodiments of the invention.

FIG. 30 illustrates an example of a graph of the observed K_{obs} and the concentrations according to specific embodiments of the invention.

FIG. 31 illustrates an example of a graph of the association (upward part of the curve) and dissociation (downward part of the curve) simultaneously according to specific embodiments of the present invention.

FIG. 32 illustrates an example of a graph of the quantitative concentration versus signal according to specific embodiments of the invention.

FIG. 33 A-B is a flow-chart illustrating performing different signal analysis methods on different portions of a fringe pattern and evaluating those different analysis methods to detect an event according to specific embodiments of the invention.

FIG. 34 is a block diagram showing a representative example logic device in which various aspects of the present invention may be embodied.

### DESCRIPTION OF SPECIFIC EMBODIMENTS

### Overview

It has been previously recognized that the interference fringe patterns produced from a BSI system is complex. For a number of reasons, the spatial frequencies of the fringes (or peaks) of the fringe pattern is generally non-uniform, non-constant, and generally contains high frequency (HF), mid-frequency (MF), and low-frequency (LF) components (see Sorenson, Risø-PhD-19(EN), PhD thesis, 2006). Sorenson applied known mathematical theory to model the empirical results for the measurement of homogeneous solutions of glycerol at varying concentrations. (Results for the measurement of homogeneous solutions varying concentrations are often used in the art, and in this discussion, as experiments to investigate or validate various methods for determining an accurate RI change from analysis of fringe shift.) From that work, Sorenson demonstrated that it is possible to create a mathematical model that emulates the shift in fringe position and phase for the measurements of a homogeneous solution of solute that does not engage in molecular complexation (i.e. bi-molecular or multi-molecular binding, molecular aggregation, or changes in unimolecular or multi-molecular conformation). Sorenson's heuristic and computational models were successful in describing how a BSI device responds to changes in bulk refractive index as the concentration of a given solute is increased in the absence of a chemical event. As such, Sorenson's models and teachings emulate the behavior of a classic refractive index detector. For the purposes of this discussion, a chemical event does not include varying concentrations of a stable solution, though such systems may be used for testing and verification purposes.

In contrast to prior art, recent empirical studies performed by Weinberger, et al., have indicated that, for actual binding and chemical events, not all spatial frequency components of the fringe pattern shift appreciably in BSI systems, creating a marked distinction from the previous art. Thus, according to specific embodiments, methods and systems as described herein generally attempt to identify portions of fringe shift that are most useful in detecting a binding or chemical event of interest. This work has focused upon determining which components of the spatial frequency of the fringe patterns provide the most reliably detectable fringe shift for the detection of a chemical event and using this understanding in systems and methods according to specific embodiments of the present invention to detect chemical event signals.

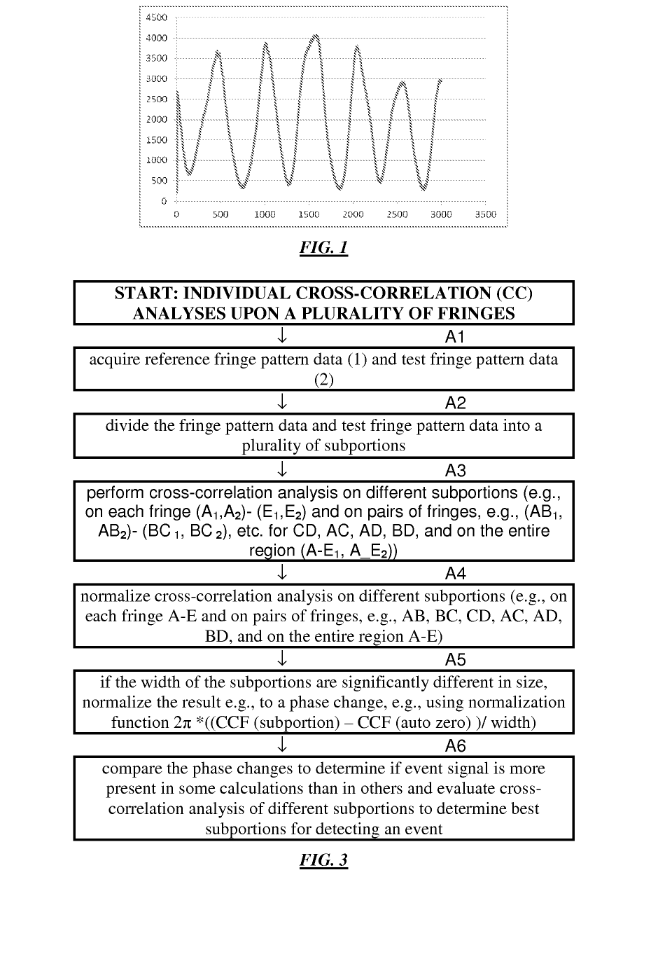

In existing BSI analysis, while the interference fringes (or peaks) originate at a centroid and extend indefinitely, detection is generally done by selecting one or more fringes some distance from the centroid (such as fringes 9-14) and measuring the overall shift of those fringes (e.g. the captured fringe pattern). One criteria for fringe selection has been selecting one fringe or a set of adjacent fringes that are in a region with a relatively uniform dominant spatial frequency, such as shown in FIG. 1. In many systems, fringe selection determines or is determined by the placement of the capture device, which generally can only capture a portion of the overall interference fringes. At least two captured fringe patterns, captured generally at two times or more of interest or (such as before, during, and after a binding event is supposed to take place) or from two or more different samples, such as different concentrations of a solution, is generally the raw data used to determine the presence of an overall fringe shift.

### The Fringe Data

FIG. 1 illustrates an example of a BSI fringe pattern captured on a 1-dimensenional 3000 pixel CCD (e.g., in this example showing five complete peaks and 2 partial peaks in 2-dimensions) for example of one refraction at one time according to specific embodiments of the invention. In many previous BSI systems, detecting of fringe shift was limited to using two or more captured fringe patterns such as shown in FIG. 1 and determining an overall fringe shift between the captured patterns.

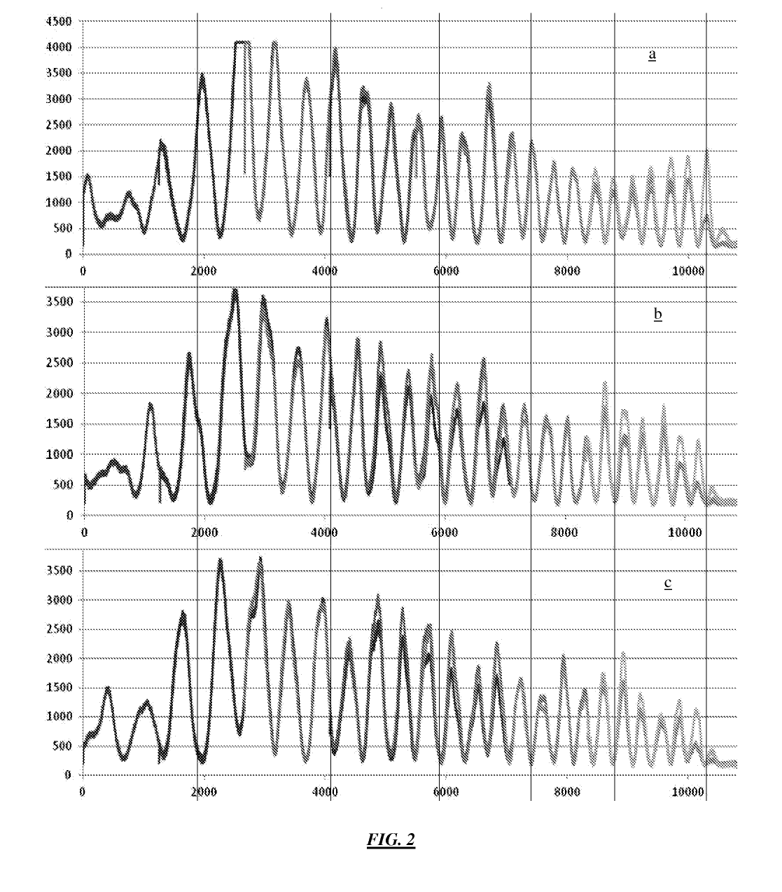

FIG. 2a-c illustrates an example of a fringe pattern as captured on using a CCD camera showing a larger number of fringes (e.g., >20) than are typically analyzed but that are available for detection of binding signal according to specific embodiments of the invention. In this example figure, the CCD camera was moved to gather a larger number of fringes. In experimental systems and methods, when determining whether a particular system or analysis is correctly detecting a fringe shift, it is common to use different concentrations of a substance that is known to provide a particular fringe shift. For example, this example shows an extended fringe pattern for (a) Water (b) PBS (phosphate buffered saline) (c) 1% DMSO (Dimethyl Sulphoxide) in PBS. In this example, the expected RI change between (a), (b), and (c) is known, so measuring that RI change using one or more fringe shift analysis methods as described herein is used to test and validate those methods for application of detecting binding events and other events that are believed to also cause an RI change. According to specific embodiments of the invention, one or more signal processing operations and operation evaluations use portions of the fringe data in ways that are more flexible and individual than just analyzing the overall fringe shift of one particular part of the data, such as one fringe pattern or one dominant spatial frequency.

### Signal Processing Operations

According to specific embodiments of the invention, a number of different signal processing operations can be applied to the fringe data to detect changes in the fringe patterns. As will be understood in the art in light of this disclosure, these operations can transform the data in a variety of ways and examine different subparts of the data, all with the goal of detecting changes in subparts of the fringe patterns that indicate the occurrence of a chemical event (and/or binding event) of interest. The various sub-portions of the fringe data that can be examined in particular operations include, without limitations: (1) individual fringes; (2) portions of fringes; (3) contiguous and non-contiguous sets of individual fringes and/or portions of fringes; (4) portions of fringe data defined by pixel-capture region, such as vertical and horizontal slices of the fringe data; (5) any combination of fringe data selected by one or more criteria in the frequency domain (e.g., via Fourier transform and/or frequency domain filtering), such as one or more non-dominant spatial frequency components alone or in some combination with a dominant spatial frequency component. It will be understood in the art that different combinations and operations of the subportions of fringes, including summing, filtering, weighted combinations, etc., and any function of subportions of fringes without limitation, can be used in signal processing operations of the invention.

In specific embodiments of the invention, as further described below, a number of different signal processing operations (at times referred to as algorithms) are applied to different portions of the fringe pattern data and then these operations are evaluated according to one or more fitness parameters to determine which operations are most useful for detecting an event of interest. The signal processing operations can include various known operations for general signal processing or interferometric systems analysis or signal processing, as well as additional operations as discussed below. In some instances, previously used signal processing operations are adapted for use on one or more subportions or individualized subportions of the fringe data According to specific embodiments of the invention, the invention is also involved with one or more signal processing operations that are novel independent of any comparisons with other operations as described herein.

U.S. patent application Ser. No. 12/655,898

Among the signal processing operations that can be used according to specific embodiments of the invention are those discussed in US 2010-0188665 A1, METHODS AND SYSTEMS FOR INTERFEROMETRIC ANALYSIS, application Ser. No. 12/655,898, optionally with modifications as will be understood from the description herein. This application discusses algorithms, methods, and techniques that are used to analyze the movement of the fringe pattern in back-scattering interferometry, including Fourier Transform (FT) and cross correlation (CC). The '898 application discusses in particular improvements directed to detecting subpixel movements.

A Fourier Transform is a well-understood method of analyzing a multi-spectral signal and expressing that signal as a sum of a number of standard frequencies (e.g., sine wives) with phase and amplitudes provided for various frequency components. In one fringe shift analysis as discussed in the application, a phase change of a dominant spatial frequency is used to detect the shift of the fringe pattern.

Application Ser. No. 12/655,898 also discusses a cross-correlation and Gaussian fit technique. Cross-correlation is often used in image or signal processing analysis and generally uses a reference image or pattern to which other images are compared or correlated. In the cross-correlation techniques, a reference pattern is selected with which other fringe patterns are compared in order to detect a shift in the fringe pattern. In many instances, calculations are performed in such a manner that sub-pixel measurements are possible.

Application Ser. No. 12/655,898 further discusses optionally transforming the pattern, e.g., by performing cross correlation, to produce a pattern for analysis; fitting a Gaussian distribution to the cross correlation for analysis at a first and second time; identifying a positional shift of the pattern by comparing a selected value of the Gaussian distributions of the pattern at the first and second times; and determining a change in overall refractive index of the liquid from the positional shift. In some instances, the pattern is a cross-correlation of two interferometric fringe patterns. In other instances, the pattern is an interferometric fringe pattern. In an example, a Gaussian distribution can be fit to an individual fringe pattern for analysis without cross-correlating the data prior to fitting the data. In some embodiments, the selected value is the maximum value. The position of the maximum value of the cross-correlation moves relative to the change in the position of the current fringe pattern to the reference fringe pattern.

In order to obtain sub-pixel resolution, application Ser. No. 12/655,898 discloses that the cross-correlation can be fit to a Gaussian distribution. An example Gaussian equation, as is understood in the art, is:

Applying the natural

$$f ( x ) = a {e}^{- \frac{{( x - b )}^{2}}{2 {c}^{2}}} \qquad 40$$

log to both sides creates a linear equation:

$$ln ( f ( x ) ) = ln ( a ) + ( - \frac{{( x - b )}^{2}}{2 {c}^{2}} ) or {f}^{′} ( x ) = {a}^{′} + ( - \frac{{( x - b )}^{2}}{2 {c}^{2}} )$$

Given f(x), a general linear least squares fit can be used to calculate b, which is the maximum of the Gaussian distribution. In this manner, selected values of the Gaussian distribution can be used to compare the cross-correlation results to a previous Gaussian distribution of a cross-correlated fringe pattern. In this example, the center of the Gaussian fit is identified and then output. The output can be stored as described previously for analysis of positional shifts of the fringe pattern.

In some instances, the maximum peak area of the cross-correlation can be fit to a Gaussian distribution. The mathematical center of the Gaussian distribution can then be determined. By monitoring the mathematical center over time, it is possible to obtain a shift value for the fringe patterns that may be sub-pixel in resolution. In other instances, the entire cross-correlation can be fit to a Gaussian distribution, for example, when analyzing a single fringe.

The '898 application also discloses a method comprising a modification of the Gaussian fit method providing a Hamming window on a fringe pattern prior to performing a cross-correlation. The Hamming window in an example is provided by:

$$w ( n ) = 0.53836 - 0.46164 cos ( \frac{2 π n}{N - 1} )$$

The Hamming window is a weighting window that can be applied to the fringe patterns prior to performing the cross correlation of the reference fringe pattern and the sample fringe pattern as demonstrated herein:

F(n)=F(n)*w(n)

The Hamming window can reduce the interference of the cross-correlation side peaks with the central peak of the cross-correlation. In some instances, the Hamming window may provide better results with a larger set of fringe pattern shapes. However, a Hamming window can create a loss of resolution when larger fringe shifts have occurred. In some instances, variations of the Hamming window shape, for example blending a square window with a Hamming curve, may reduce the noise and improve the results for the fringe pattern shapes commonly seen with back-scattering interferometry.

### Method 1 Individual Cross-Correlation (CC) of Subportions of Fringe Data

As discussed above, analysis according to specific embodiments of the invention has determined that the fringe pattern is comprised of constructive and destructive interference patterns that arise from the chip and radiate at increasing angles from the point of incidence to form a pattern of alternating regions of constructive interference (a fringe) and destructive interference (a dark region between fringes). As the angle increases from the central reflection, the angle of change between the fringes decreases (the fringes get smaller).

Thus, according to specific embodiments, one signal analysis operation of the present invention comprises: performing individual cross-correlation (CC) analyses upon a plurality of sets of fringe data, including cross-correlating fringes or portions thereof between at least a first captured data set (e.g., a reference captured data set from a reference sample) and a second captured data set (e.g., a test captured data set from a test sample), the CC between one or more of individual fringes, portions of fringes, and combinations of fringes or portions of fringes from the two data sets. In specific examples, the invention sums the change in fringe position between the first data set and the second data set determined by CC of individual components as a composite signal. In this manner, a plurality of fringes can be simultaneously interrogated as to their change between two data sets using the sensitive CC approach, allowing for the monitoring of binding signal irrespective of to which fringes or portions of fringe data that the binding signal is distributed.

FIG. 3 illustrates a flowchart showing an example cross correlation operation according to specific embodiments of the invention.

### Method 2 Fourier Transform (FT) of Sliding Windows

A second operation according to specific embodiments of the invention comprises performing a plurality of FT analysis to a sliding window of fringes from at least two data sets and then summing the resulting change in fringe position. This has some similarities in rationale to the operation described above, but uses a different mathematical approach.

In a specific embodiment, a Fourier transformation (FT) measures a single frequency (for example, the dominant spatial frequency, such 5 in FIG. 1) and calculates the phase change of that frequency between the two data sets. However, as the angle between fringes decreases, e.g. as one moves further out from the centroid in FIG. 2, the FT is unable to measure a constant frequency across a large number of fringes. According to specific embodiments of the invention, by taking a small window or region of fringes, convolving the fringe pattern with a modified Hamming window (or other types of filter or window as will be understood in the art), the FT can then be performed on multiple windows or regions of the fringe pattern without the larger distorting effects of the change in the fringe pattern frequency over the entire measured fringe pattern. Each measured window will generally have a different relative phase change value between the two data sets under this analysis. Thus, according to specific embodiments of the invention, the fringe shift is expressed as multiple phase changes. As one simple example, consider FIG. 2. According to specific embodiments, each 2000 pixel window starting at 0 can be analyzed by FT to determine a shift, thus producing five shifts for 0-2000, 2000-4000, 4000-6000, etc. While these equal sized adjoining windows provide a good example, the method can use various sizes, non-contiguous, and even overlapping windows.

As described above, if different regions of the channel produce the binding signal, and the binding signal is therefore translated to some but not all of the fringe pattern, the multiple windows or regions of the fringe pattern that have been measured will show different signal changes.

Using the multiple measurements, as further evaluated herein, the phase change of individual regions is measured and can be used to detect an event. In some embodiments, if the phase change signals are summed, non-correlated noise may be reduced by the square root of the number of regions that are summed.

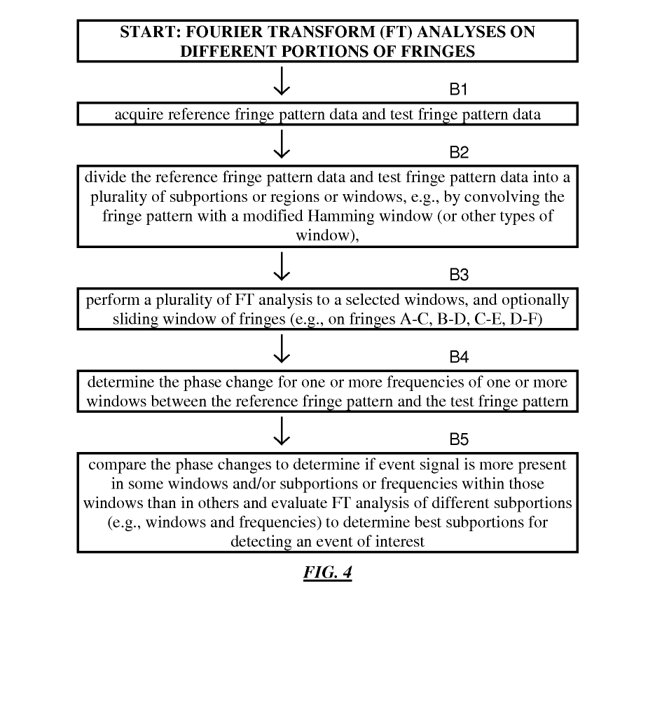

FIG. 4 illustrates a flowchart showing an example sliding window FT operation according to specific embodiments of the invention.

### Method 3 Forward and Reverse FT Acting to Modify or Reduce Specific Frequencies

In a further embodiment, the fringe pattern is comprised of constructive and destructive interference patterns that arise from the chip and radiate at increasing angles from the point of incidence to form a pattern of alternating regions of constructive interference (a fringe) and destructive interference (a dark region between fringes). The cross correlation function (CC) measures a change in position of the entire region that the CC is performed upon. (The CC historically has been performed on a single fringe between the two data sets. According to specific embodiments of the invention, CC can be performed on multiple fringes or on portions of fringes or any combination thereof.) As the position change is calculated upon the entire region, including “noise”, the refractive index change from the binding signal may be lost within the “noise.” By first performing an FT on a region of multiple fringes, and then setting the magnitude of unwanted frequencies to zero and then performing the reverse FT, a fringe pattern can be created of only the desired frequencies. The fringe pattern may then be measured with one or more CC regions.

Thus, a third operation according to specific embodiments of the invention comprises performing a forward FT and reverse FT operation to function as a notch filter to interrogate a given frequency domain for some or all fringes within a given experiment and then analyzing the output signal as either individual components or as combined in the two operations described above. Notch filtering, as will be understood in the art, is a technique for selecting out one or more particular frequency ranges in a multispectral signal and attenuating other frequencies. As discussed above, each frequency can thereby be separately analyzed for a fringe shift due to a chemical event and an individual frequency or combinations of frequencies can be used for detecting a chemical event.

In further embodiments, the steps are performed on a “reference” and “test” fringe patterns effectively in parallel. In specific embodiments, the same operations may be performed on both for a number of steps. The filter, as discussed above, essentially performs the function of modifying or removing one or more spatial frequencies. Thus, “notch filter” is used broadly herein to indicate any operation that selectively modifies or removes one or more spatial frequencies or ranges of spatial frequencies.

An example of these steps can be further understood as follows. (a) Acquire a reference fringe pattern. (b) Perform an FT or similar transformation on the reference fringe pattern to obtain magnitude data and/or phase data for a plurality of frequencies. (c) Reduce or set to 0 selected frequencies’ magnitude(s), depending on what filtering is desired. (d) Perform reverse FT or similar transformation to create a modified reference fringe pattern. (e) Use the modified reference fringe pattern on one or more modified test fringe patterns that are acquired and created as follows. (f) Acquire test fringe pattern. (g) Perform an FT or similar transformation on the test fringe pattern to obtain magnitude data and/or phase data for a plurality of frequencies. (h) Reduce or set to 0 selected frequencies' magnitude(s), depending on what filtering is desired. Optionally this is the same operation as in step c above, but it is not necessarily so. (i) Perform reverse FT or similar transformation to create a modified test fringe pattern. (j) Apply other technique or signal analysis operation, such as CC, to one or more regions, using the “modified reference fringe pattern” and the “modified test fringe pattern” to calculate the CC.

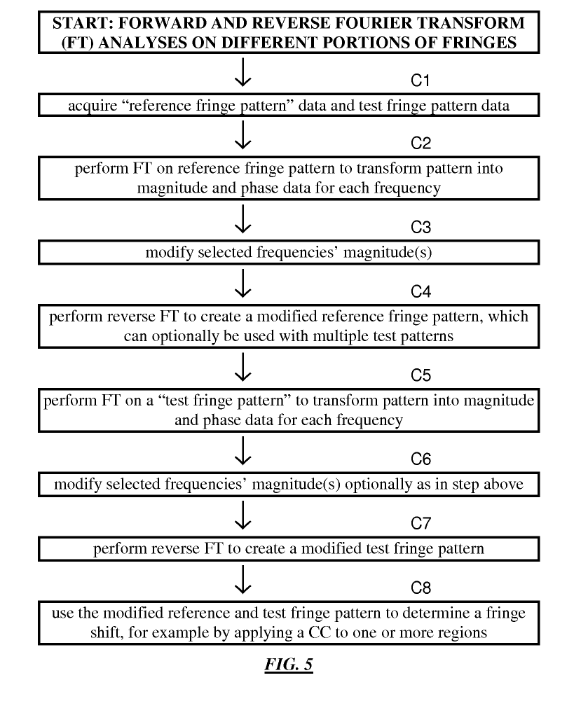

FIG. 5 illustrates a flowchart showing an example of performing a forward FT and reverse FT operation to function as a notch filter according to specific embodiments of the invention.

Experimental Work: According to further specific embodiments, a software tool, known as a spatial frequency spectrum analyzer provides a spatial frequency spectrum analysis that displays spatial frequency magnitude and phase for a set of fringes. This tool was used to display the magnitude and phase of different spatial frequencies for difference regions of the fringe pattern files (i.e. different concentrations of ligand binding to a target.) Generally, 3-9 different regions were selected that covered from low to high ligand concentration range.

FIG. 6 illustrates an example of a graph of frequency vs. magnitude and frequency vs. phase shift according to specific embodiments of the invention. Phase and magnitude plots for different concentrations of ligand binding to the test target are depicted by the various line colors for each plot. As shown in FIG. 6, at certain frequencies, in the particular experimental setup described below, the dependence of phase shift on ligand concentration was stronger than others. In other words, there existed specific spatial frequencies for which change in phase was positively correlated with change in ligand concentration. According to specific embodiments, frequencies with high dependence on ligand concentration and are used to generate a new fringe file, by the application of a reverse FT. The resultant fringe file can then be analyzed by using the previously described variety of mathematical algorithms, which include CC and various difference algorithms.

The figure illustrates a plot of magnitude vs. frequency for an exemplary two-component binding system of carbonic anhydrase (CAII), an enzyme target, and dansylamide (DNSA), a ligand. Spatial frequency magnitude is expressed in selected normalized units of 0-350,000. Spatial frequencies of about 1 to 20 are shown with different magnitudes associated therewith, with the largest components at 11 and 8. Phase shift vs. frequency is shown in the lower panel at difference concentration (1-8) of DNSA as displayed by the spatial frequency spectrum analyzer.

FIG. 6 also illustrates phase as a function of frequency. There are multiple plots in each panel, which correspond to different fringe data capture times in the data file. For this experiment, at the different times different samples are introduced into the BSI. As illustrated, according to specific embodiments, the invention can thereby determine the spatial frequencies that show the greatest phase shifts and therefore perform better with respect to signal to noise and that response is correlated with the response in binding energy. In this example, a frequency around 5 in lower panel is associated with a large phase shift, as is a broad range extending from 8-12 and around 14. The phase change for spatial frequencies from 15-17, although quite extensive with appreciable signal to noise, do not correlate with the change in ligand concentration, and as such, are not used for the reverse FT operation. In other words, appropriate spatial frequencies are determined if there is a distinct quantization of phase as a function of analyte concentration. It is generally hard to predict what frequency domain the binding signal will manifest in the instrument, but using a method as illustrated herein a filter can be applied and used to find the binding signal.

Thus, according to specific embodiments, different filters are applied to filter unwanted spatial frequencies. From the wave form, apply a number of mathematical algorithms to figure out time dependent signals. Accordingly, for the present example, spatial frequencies ranging from 3 to 9 were chosen to perform the reverse FT and create the subsequent fringe files for analysis.

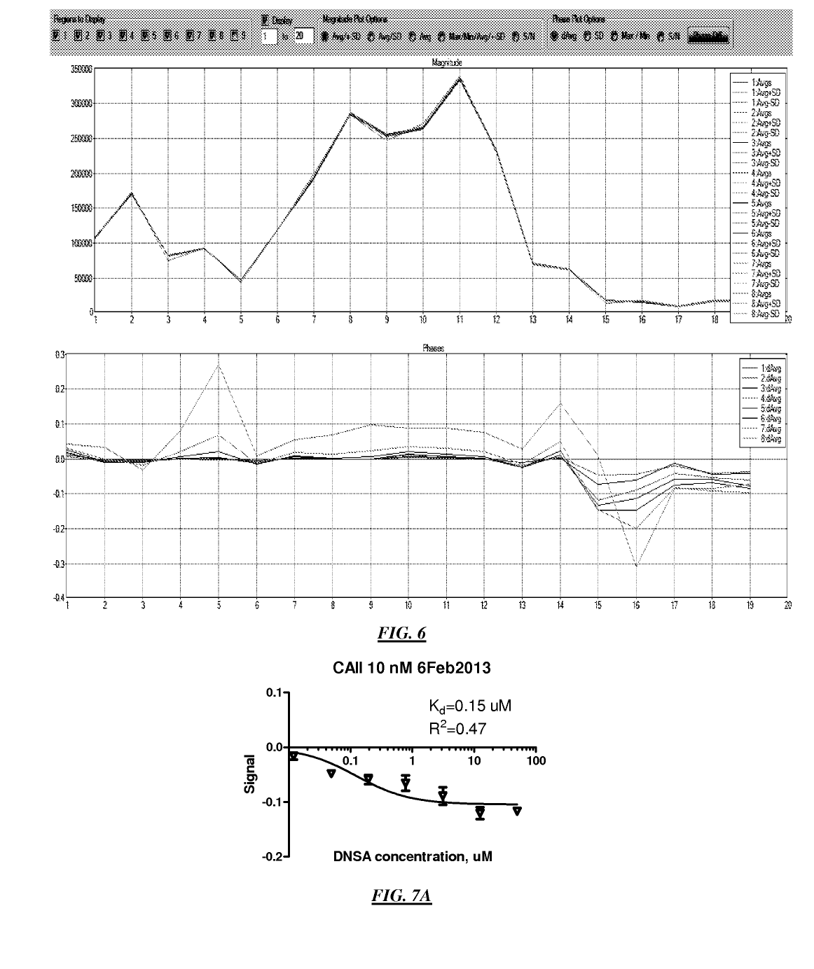

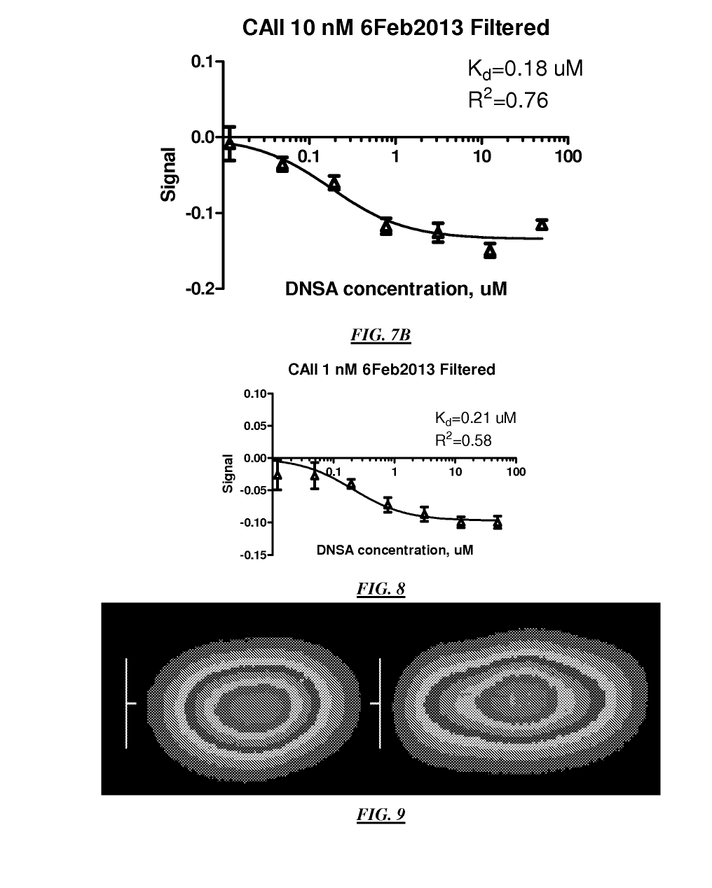

FIG. 7A depicts the resultant binding curve for the previously described system that is created by using the conventional method of performing a FT analysis upon the spatial frequency of greatest magnitude. As can be seen, the resulting binding curve is of poor quality, with an R² value of less than 0.5, providing no confidence in the determined equilibrium dissociation constant (K_{d}). In this instance, applying the previously established methodology of analyzing spatial frequencies of the greatest magnitude fails to provide acceptable results.

As showed in FIG. 7B, a binding curve with higher R² value was obtained after fringe filtration according to specific embodiments. In addition, the filtration of fringe was helpful to improve the consistency and sensitivity of CAII assay with the variation of assay conditions. For example the same CAII assay was repeated with lower enzyme concentration (1 nM instead of 10 nM; FIG. 8). No binding curve was observed when the data analysis proceeded using the convention method. After fringe filtration according to specific embodiments, a binding curve with reasonable K_{d} value and R² was obtained.

These experiments illustrate that the above method using a plurality of fringes and plurality of algorithms provides a superior binding curve as analyzed by using R² plus noise. The method allows spatial analysis to facilitate the selection method as described above.

### Experimental Sample Preparation

10 ul Dansylamide (DNSA) stock solution (10 mM) in DMSO was added into 990 ul Phosphate buffer (PB) (20 mM, pH7.0) to a final concentration of 100 uM. A series of solutions with the concentration range of 12 nM˜50 uM were prepared by 4× dilution by that PB buffer with 1% DMSO. Carbonic Anhydrase II (CA II) stock solution 20 uM was diluted by PB buffer with 1% DMSO to a final concentration of 2 nM or 20 nM. The DNSA solution was mixed with CAII solution with the volume ratio of 1:1 for assay sample or PB buffer with 1% DMSO for control sample.

### Method 4 Fourier Transform, Non-Dominant Frequency

As previously described, the each captured fringe pattern created in interferometric analysis is comprised of a variety of spatial frequencies, whose presence can be detected and monitored for change between captured fringe patterns by applying a variety of mathematical approaches that include cross-correlation, difference, and FT operations. These various mathematical approaches are also referred to at times herein as signal processing or signal analysis operations or algorithms With respect to FT analysis of BSI fringe data, prior art teaches the application of FT analysis upon the principle or dominant spatial frequency of the BSI fringe data. While this approach is useful for detecting changes in the bulk signal or colligative properties of the probed volume, it has been determined by one or more of the present inventors that monitoring only the dominant FT spatial frequency fundamentally fails to capture the binding energy of unique chemical events, which manifest in minor or other spatial frequency domains of a BSI fringe pattern.

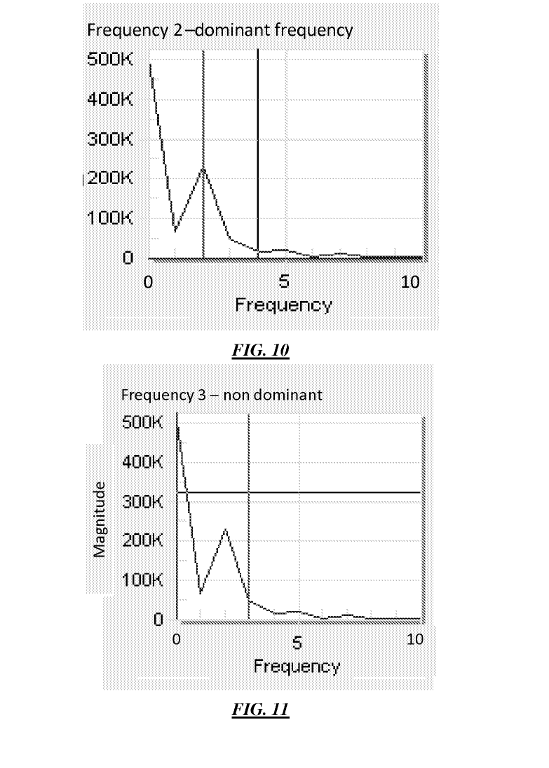

As an example, using teachings provided herein, it has been discovered that the chemical event signal for a bi-molecular binding system of an enzyme, acetylcholinesterase (Ache) and its ligand, propidium iodide (PI), is predominantly manifested in a non-dominant spatial frequency domain of a BSI fringe pattern. FIG. 9 depicts a computer generated 2-dimensional image of two specific BSI fringes captured by a 2-dimensional CCD array camera. These fringes were generated by monitoring the interference pattern generated by the Ache assay buffer in the absence of Ache or PI. FIG. 10 depicts the FT analysis of this fringe pattern. As can be seen, a dominant spatial frequency is identified as spatial frequency number two. A minor frequency component of the same system is depicted in FIG. 11 (frequency number three).

In this experiment, each FT derived spatial frequency was monitored between different captured fringe data sets and their change in phase (y-axis) plotted as a function of PI concentration (x-axis) to determine the change in measured refractive index during the Ache assay, as subsequent mixtures of a constant amount Ache and titration series of PI were measured in the BSI device. The resultant binding curves are illustrated in FIG. 12. As can be seen, a strong binding signal with excellent signal to noise ratio is created when monitoring the change in phase for the minor spatial frequency. Moreover, cross correlation (CC) analysis of these two fringes, as well as phase analysis of the predominant FT derived spatial frequency did not as effectively detect or measure appreciable binding signal.

Thus, this graphically illustrates one example of testing number of operations and subportions, as described further below, and determining which operation and data subportion best work to detect a binding or chemical event signal in a particular system. In this case, the operation selected was an FT analysis and the subportion was spatial frequency 3. It is of further interest to note that the highest sensitivity and quantification performance obtained for the analysis of a glycerol dose response curve within the Ache binding buffer was obtained using a different operation/data combination, in this example the phase analysis of the dominant FT frequency component, further substantiating the invention's approach of selecting operations and data portions for an event that may be different from those used to detect simple refractive index changes for colligative property measurements.

### Method 5 Fringe Pattern Difference

Fringe Pattern Difference is a new computational means to describe changes in fringe position or in fringe shape as manifested by BSI measurements of chemical events. In this section, exemplary data is conveniently generated using a standard glycerol dilution series, which by definition does not constitute a chemical event. It should be noted that the proprietary Fringe Pattern Difference operation can also be applied to the study of chemical events, and that the use of exemplary glycerol data is not restrictive in any means or manner Returning to FIG. 1 as an example, FIG. 1 illustrates an example of a BSI fringe pattern captured on a 1-dimensenional 3000 pixel CCD (e.g., in this example showing five complete peaks and 2 partial peaks in 2-dimensions) for example of one refraction at one time according to specific embodiments of the invention. As can be seen from the figure, in this particular example, illumination intensities are measured on a scale of 0-4500 and intensities of between about 400 and about 4000 are captured at each pixel. The numerical values used to express the illumination level are generally arbitrary and can be adjusted or normalized in various ways, as will be understood in the art.

FIG. 1 according to specific embodiments of the invention can be understood to represent a single “captured fringe pattern” captured at a particular instant of time on the CCD camera. This fringe pattern shows five complete spatial fringes, with fringe peaks at pixel positions of about 500, 1050, 1600, 2100, and 2600. It will be understood that these generally would represent 5 adjacent fringes selected at some distance away from the centroid, at a distance where the fringe pattern is of a sufficient intensity and provides other desirable signal characteristics for measurement, such as somewhat uniform spatial frequency in the region of interest. Fringes can be generally numbered at a distance away from the centroid. Thus, FIG. 1 can represent fringes 6, 7, 8, 9, 10 or fringes 9, 10, 11, 12, 13 (depending on the placement of the capture device with respect to the total BSI fringe pattern) of a fringe pattern at a particular instant of time. As discussed in some of the above references, a time series (generally 2 or more) of such captured data is analyzed to determine a fringe shift and thereby detect a change in refractive index.

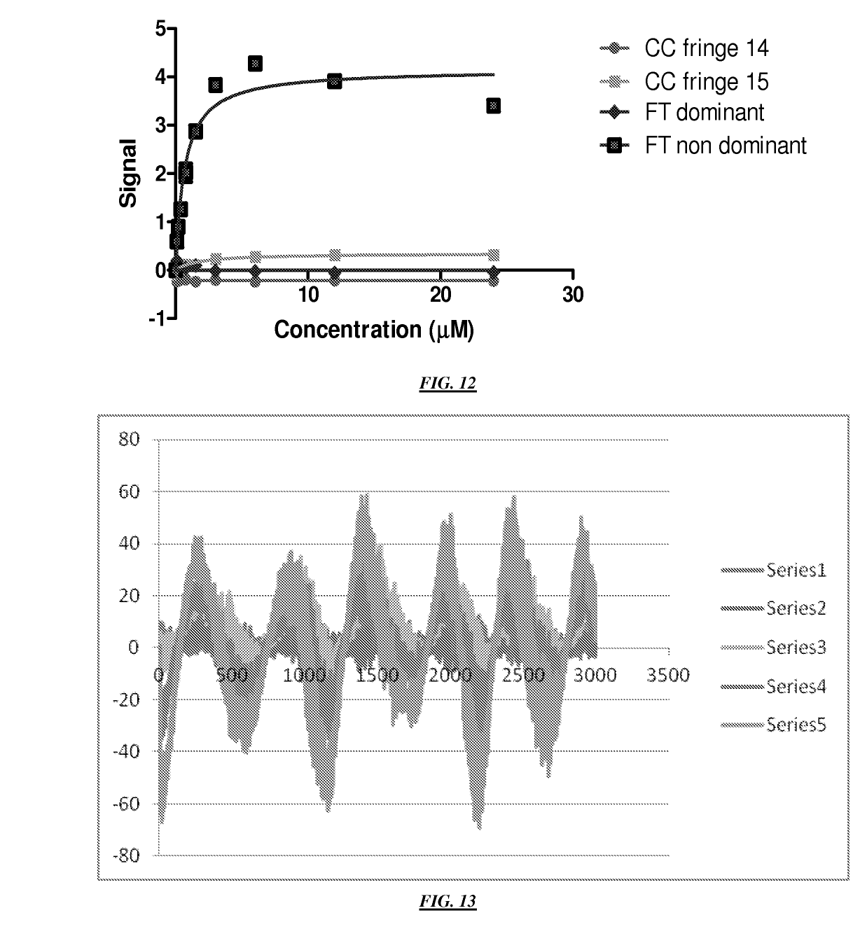

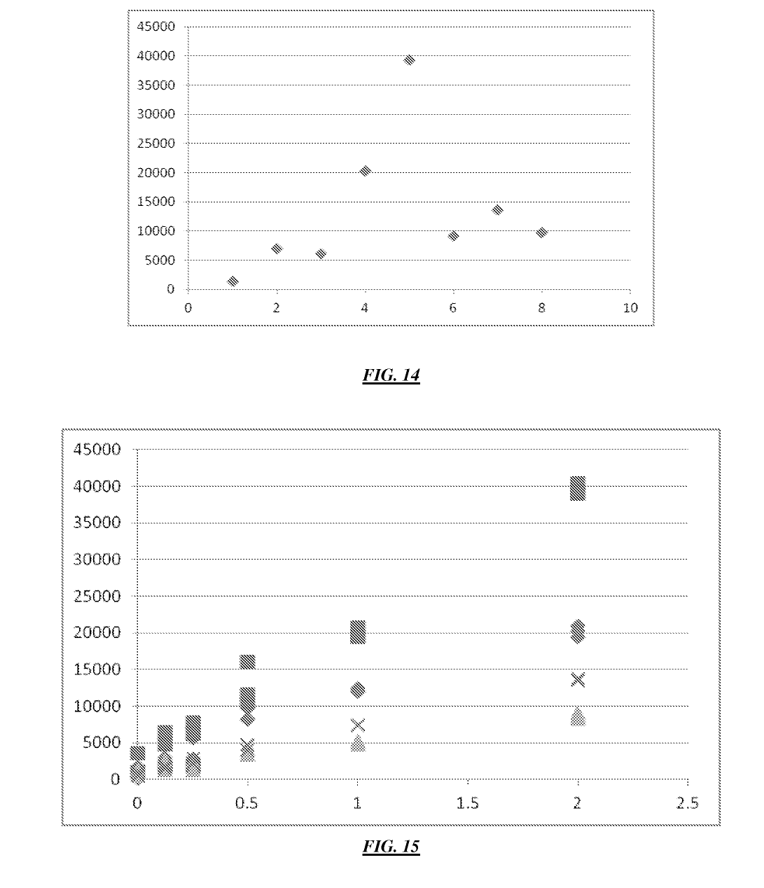

FIG. 13 illustrates an example of a difference plot of a time series (t1 to t5) of five captured BSI fringe patterns from five times with an increasing concentration of a substance known to cause an increasing refractive index and with each fringe pattern normalized by subtracting a first reference fringe pattern (e.g., Series 0) from it and normalized according to specific embodiments of the invention In one example, this figure can be understood to represent a subtraction of one reference fringe pattern (such as a Series 0) pattern from each subsequent pattern. By taking the difference of the fringe patterns FIG. 13 illustrates an increase in the RI change from series 1 to series 5 corresponding to an increase in concentration of the test analyte, which in this case is glycerol.

A Fourier transform of the data provides a dominant frequency (for the series 5 data) FIG. 14 illustrates an example of Fourier transformation (FT) of the series 5 (t5) data as shown in FIG. 13 from the highest concentration showing a dominant spatial frequency at 5, with smaller spatial frequency components at 4 and 6-8, according to specific embodiments of the invention. Plotting the magnitude vs. the concentration of glycerol (which provides a known increase in refractive index), demonstrates that there is a linear response for not only the dominant frequency but for other frequencies as well, as is shown in FIG. 15. FIG. 15 illustrates an example of linearly increasing amplitude of the different frequency components of the experimental data as shown in FIG. 13 according to specific embodiments of the invention In this figure, the green triangles indicate the change in frequency amplitude for spatial frequency 6 from the FT analysis, the blue diamonds indicate the change in frequency amplitude for spatial frequency 4 from the FT analysis, the red squares indicate the change in frequency amplitude for spatial frequency 5 from the FT analysis, the purple X's indicate the change in frequency amplitude for spatial frequency 7 from the FT analysis. The X-axis in the figure indicates from 0 to 2.5 millimolar of glycerol in the time series, with t₁=0.125 milli-molar, t₂=0.25, t₃=0.5, t₄=1.0, and t₅=2 milli-molar. In this figure, three data points are shown for each concentration, representing three different runs of the experiment. This analysis demonstrates that using this method of subtracting a reference fringe pattern from a fringe pattern, different frequency components can be examined independently for event or binding signal.

The characteristics of the difference patterns as described above allow the difference to be used to detect binding events, either alone or in combination with other methods.

### Method 6 Adding Differences Between Minima and Maxima

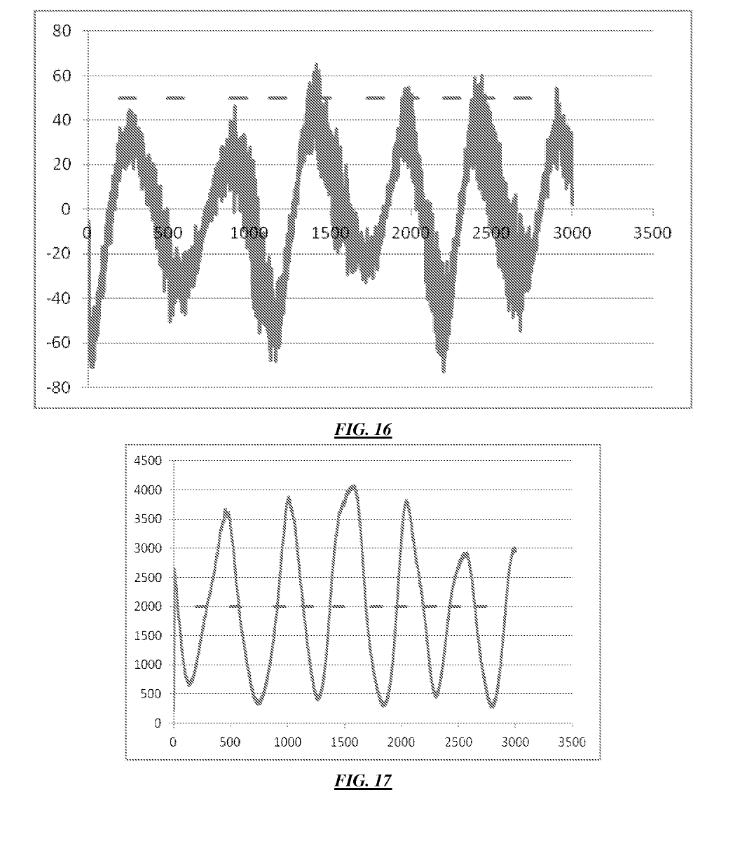

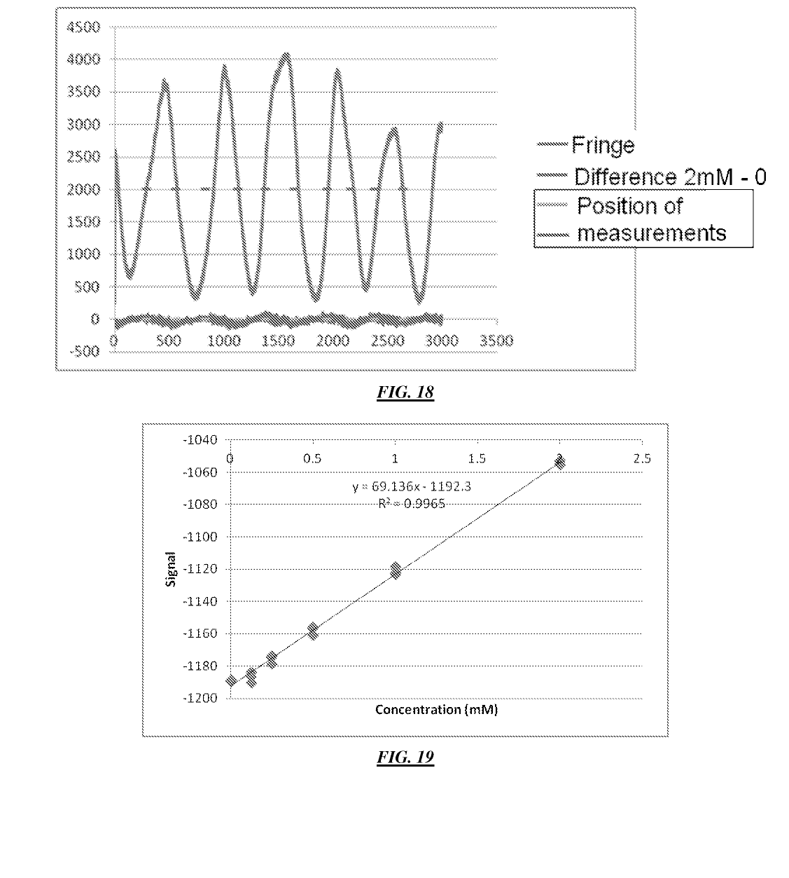

The second operation uses the same first steps (direct subtraction of 5−0) as the previous operation but instead of performing an FT on the difference, this method takes the difference between the minima and the maxima of each difference (of each fringe) and adds them. The response is linear and has been shown in some instances to be more sensitive than the previous operation. FIG. 16 illustrates an example of the difference plot of the 2 millimolar (mM) fringe pattern minus the reference fringe pattern (Series 5−Series 0) as shown in FIG. 13.

FIG. 17 illustrates an example showing the Series 5 data and the red horizontal dash lines show in FIG. 16 indicating the minima and maxima according to specific embodiments of the invention. From FIG. 17 can be seen that the minima and maxima positions generally occur at places of high slope. According to specific embodiments, the larger the difference between the minimum and the maximum the more fringe is indicated.

FIG. 18 illustrates the FIG. 16 and FIG. 17 data shown on the same graph according to specific embodiments of the invention. FIG. 19 illustrates an example showing a difference at concentrations between 0 and 2 according to specific embodiments of the invention.

### Method 7

According to specific embodiments, this methods skips the step of taking a difference of the fringes and analyzes the sections of the fringes as in the operation just above. This operation has shown to be linear as well. Additionally, the analysis can be performed on individual fringes as well as combinations to determine if they all respond equally. Experimental data to date suggests that in some examples, certain combinations of fringes perform better than a single fringe alone. In the previous two operations, the number of pixels of each region can be varied to determine the best sections for analysis.

### Method 8 Using FT to Adjust CC

For those measurements for which BSI binding signal is discovered to be preferentially derived from a fringe or fringes or a portion of a fringe or fringes and further processed using a specific numerical operation or operations, it is possible to leverage this phenomenon to improve binding signal fidelity. In BSI and similar assays, there are sources of correlated and uncorrelated noise. Uncorrelated noise is random in nature and does not correlate with any refractive index signals being measured. Uncorrelated noise arises from various sources that include but are not limited to electronic noise, microphonic or vibrational noise, and optical noise. Correlated noise is that noise which arises from specific sources that systematically affect or perturb refractive index. Sources of correlated noise include but are not limited to such things as variations in sample injection (e.g., injection irreproducibility) that manifest as changes in measured refractive index, thermal variations in the probed region, thermal variations in the optical bench, as well as refractive index changes in analytical solutions due to differences in solvent composition that do not affect unimolecular or multi-molecular binding signals. Correlated noise is not random in nature, and if isolated from the signal of interest, can be mathematically described and subsequently removed from the measured signal for BSI molecular interaction studies.

In the following example a molecular interaction study was performed between an enzyme (myeloperoxidase) and an enzyme inhibitor (4-aminobenzoic hydrazide: ABH). Using the embodiments described herein, the ABH binding signal was found to be preferentially found in a specific fringe as numerically analyzed using a cross-correlation function. The binding signal for this system was not detected using FT analysis. However, during the analysis significant deviations in FT signal from the presumed background are observed from sample to sample and injection to injection within samples, these deviations arise from injection irreproducibility and are used to improve the signal in the more sensitive CC operations that do contain apparent signal changes upon increases in enzyme-inhibitor complex. The previously described approach can be applied to any binding signal when performing molecular interaction studies or quantitative analysis.

A binding signal is apparent when switching from FT to a CC operation. Standard deviations are correlated from one operation to another, perhaps suggesting that “injection error” is correlated and may be exploited.

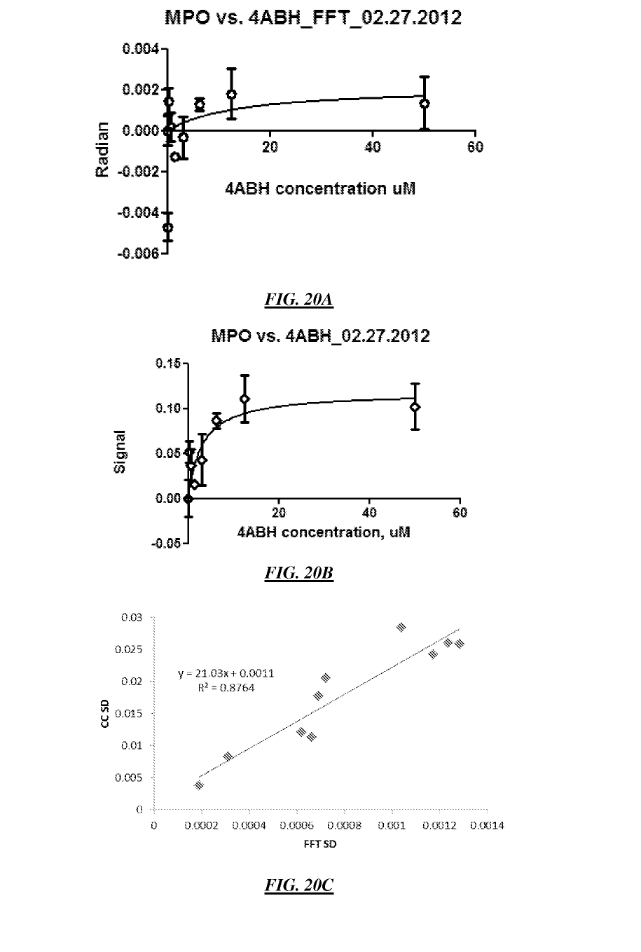

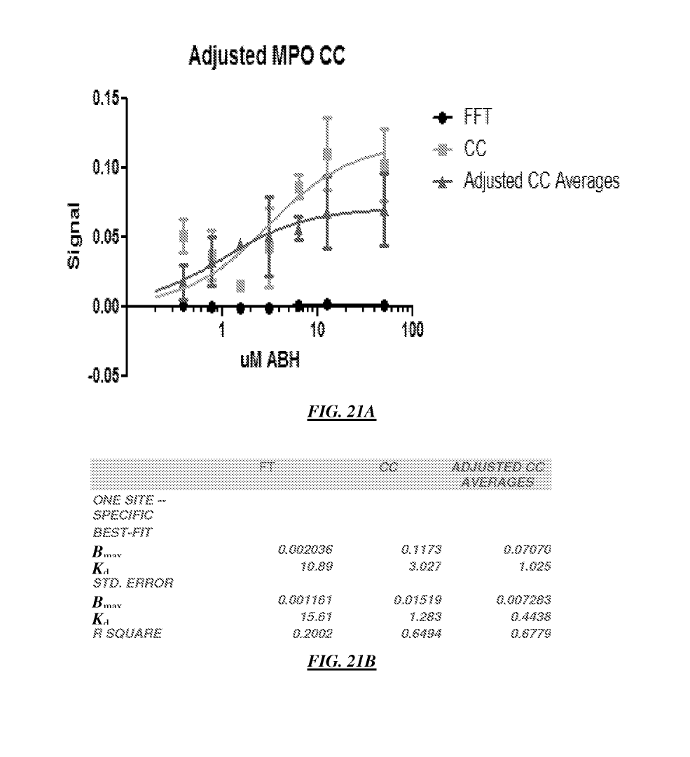

FIG. 20A-C are a series of graphs illustrating that a binding or event signal can be seen when switching from an (A) FT operation to a (B) CC operation and (C) showing that standard deviations of both FT and CC data are correlated suggesting that some sources of noise such as “injection error” are correlated and may be used as described herein for adjustment according to specific embodiments of the invention.

In one example analysis according to this aspect, the invention assumes that the FT assay signal should be flat (e.g., all injections should give approximately the same signal). In one example technique, the deviation from the mean for the average FT signals is multiplied by the average ratio of CC standard deviations to those from FT to arrive at a correction factor and this correction factor is effectively subtracted from the average CC signals. This corrects some “bad” points at the low end of the curve, yielding a more accurate K_{d} in some situations. In this technique, R² of the plot may be only marginally improved as the SD for the points aren't affected.

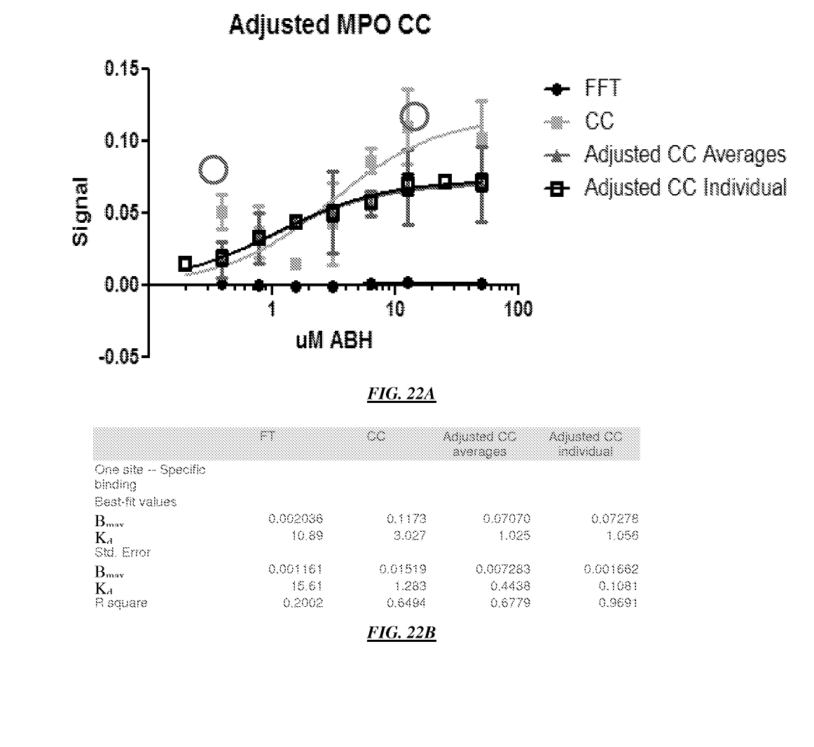

FIG. 21A-B illustrate a comparison between an FT signal assay and a CC assay and adjusted CC factors according to specific embodiments of the invention wherein the deviation from the mean for the average FT signals is multiplied by the average ratio of CC standard deviations to those from FT to arrive at a correction factor that is subtracted from the average CC signals. (B) Illustrates the affect of the correction on the best fit and error factors.

Signal Adjustment Scheme, Individual

In this modification, the deviation from the mean for individual FT signals is multiplied by the average ratio of CC standard deviations to those from FT to arrive at a correction factor that is then subtracted from individual CC signals. This produces a similar K_{d} as above, but vastly improved R² and reduced uncertainty in K_{d}. In this example, note that points at 0.195 and 25 uM were omitted from the original plots for being “bad” (these were also excluded determination of the FT mean). This adjustment scheme rescues those points and places them squarely on the binding curve.

FIG. 22A-B illustrate a comparison between an FT signal assay and a CC assay and adjusted CC factors and CC individual factors according to specific embodiments of the invention wherein the deviation from the mean for the average FT signals is multiplied by the average ratio of CC standard deviations to those from FT to arrive at a correction factor that is subtracted from the average CC signals. (B) Illustrates the affect of the correction on the best fit and error factors.

While the previous examples demonstrates the use of an FT correction factor to improve assay outcome as challenged by injection irreproducibility, it should be noted that this correction factor can be applied to compensate for any bulk refractive index source of correlated assay noise, which is detected by any combination of fringes and operation that responds to bulk refractive index changes and not to binding signal. Examples of the latter include such things as bulk refractive index changes secondary to thermal changes in the probed solution, thermal changes in the instrument's optical train, as well as bulk refractive index change related to changes in sample buffer composition.

Specific Vs. Total Binding Model

In some situations, the total binding model is preferred over the specific binding. This is particularly true in systems that repeatedly show an offset between the zero and lowest ligand concentration where binding would not be expected to contribute. The adjusted data according to this model is far less sensitive to choice of binding model.

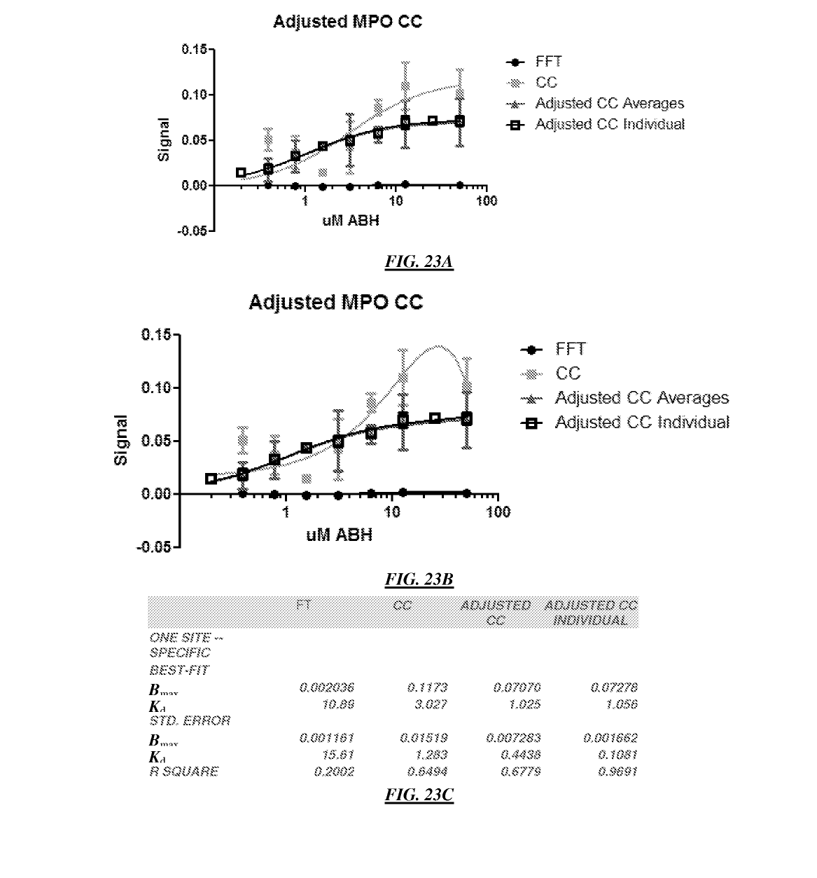

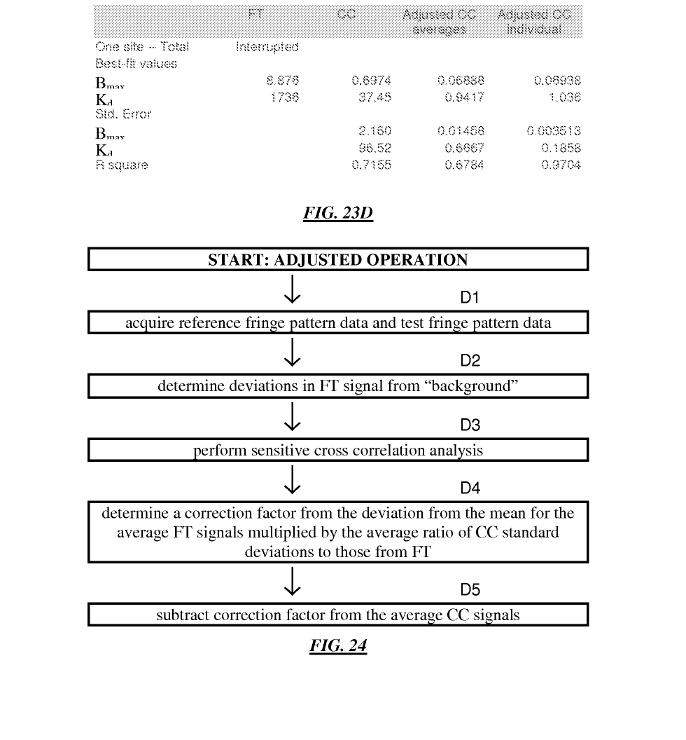

FIG. 23A-D illustrate a comparison between a total binding model and a specific binding model according to specific embodiments of the invention with (A) showing a graph of the specific model, (B) showing a graph of the total model (C) showing a table with curve fit values for the specific model and (D) showing a table with curve fit values for the total model.

### Method 9 Boundary Selection for Non-Dominant FT Analysis

Back-Scattering Interferometry (BSI) is a refractive index (RI) detector that utilizes an illumination source, a fluidic container, and a detector. A fringe pattern, a series of bright and dark spots is created by positive and negative interference of the light on the fluidic container. The shift in these fringes corresponds to a change in RI. Different algorithms and techniques have been utilized to analyze the movement of the fringe pattern in BSI, including Fourier Transform and multiple variations of cross correlation. In the Fourier Transform technique, the detector is positioned to detect several fringes (or peaks) that have a single spatial frequency. The change in the position of the fringes between two different captured fringe patterns corresponds to a change in the phase of the frequency using Fourier analysis. Use of various Fourier Transformation (FT) and Fast Fourier Transformations (FFT) to various types of signals are well known in the art. In fringe shift detection, however, application of the FT is generally used specifically to measure a positional shift between two interferomic fringe patterns that have a spatial frequency in order to identify a change in RI.

In the cross correlation techniques, a reference pattern is selected generally with which all other fringe patterns are compared to detect shifts in the fringe patterns. Calculations can be performed in such a manner that sub-pixel measurements are possible.

In further embodiments, a method according to specific embodiments allows the analysis of multiple non-integer frequencies using FT or FFT. Traditionally, when FT is performed on a pattern, the start and stop locations are both on valleys or both on peaks. This is done generally in order to obtain a single dominant spatial frequency to measure the movement of the fringes. However, investigation has demonstrated that the binding signal does not (in other words the fringes do not) completely fit into a single frequency and thus the traditional method eliminates potential signal. Analysis of non-dominant frequencies demonstrated that there were signals useful or of interest to the detecting that are located in other frequencies.

Prior systems and methods have generally only monitored binding signals using the dominant frequencies in the spatial array and thus have not generally examined boundary data. As discussed above, it has been determined by the inventors, that binding energy or signal can be found in different and non-dominant spatial frequencies. In general, there is a fundamental limitation to the FT, which performs frequency analysis using integrals that are generally limited to full peak to peak or trough to trough signals. According to specific embodiments, the start and stop conditions for the FT are altered to allow the FT to determine those other non-dominant spatial frequencies.

Thus, according to specific embodiments, once the assumption is gone that a single dominant frequency is necessary for measuring a fringe shift or RI shift, by varying the start and stop locations, a method as described herein is able to analyze captured data looking at different non-integer spatial frequencies of the pattern. For example, a binding signal or chemical event in frequency space with a frequency of 3.5 gets broken down into several frequencies in prior methods and any binding signal at that frequency is also split into those corresponding frequencies. Thus, if the FT was established to determine only integral values of the spatial frequency array, the binding signal at frequency 3.5 could be completely missed.

The present method avoids this problem by incrementing and/or decreasing (e.g., walking through) the boundary pixels for start and stop conditions as described herein. This can be accomplished by incrementing the pixels horizontally by some number, N, which can be 1 or a different value, and performing the FT each time using the new pixel as the boundary.

After moving the pixels for the boundary conditions and performing an FT, the resultant FT analysis (e.g., 50-200 different FTs) are analyzed as described herein for other methods by picking the FT that best meets the selection criteria. FT may be performed with boundary conditions moved for example every pixel, every 10th pixel, or larger chunks.

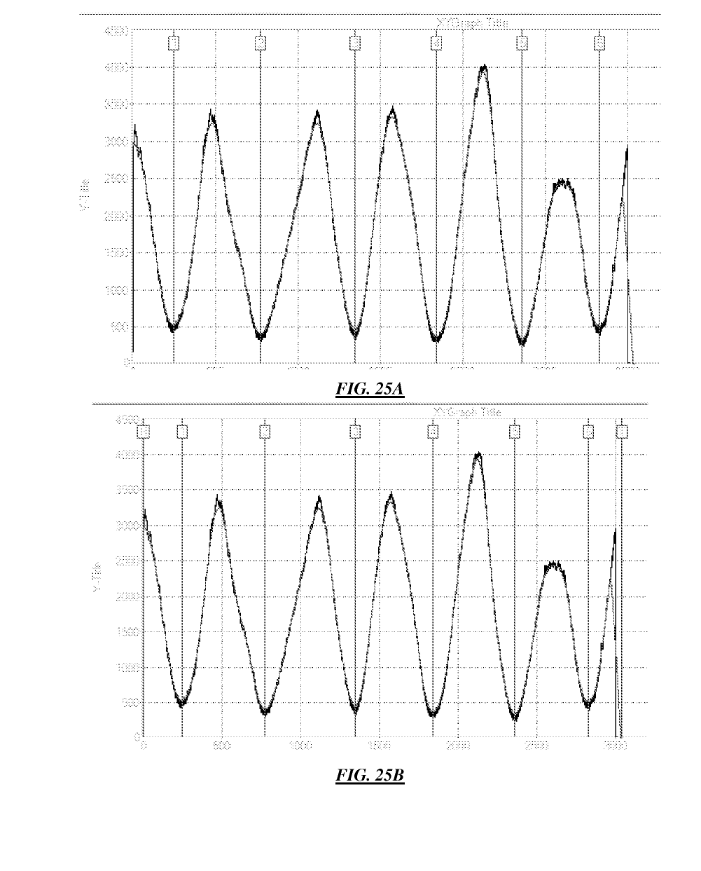

FIG. 25 A-B illustrates varying the start and stop locations of the captured fringe data and including partial peaks or patterns on the side according to specific embodiments. In A, FT analysis is applied to the window defined between minima 1 and 6. In B, FT analysis is applied to include the partial peaks that bound the previous FT window (H and T).

FIGS. 25A and B are example plots of a fringe pattern. The red signposts indicate the troughs. In FIG. 25B are shown green signposts indicating the new start and stop points (labeled H and T) when partial peaks are used in the FT or FFT. FIG. 25A shows a selection for FT analysis that is trough to trough (typically establishing the start location at post 1 and the end location at post 6), excluding the partial (e.g. half) fringes to the left and right.

FIG. 26 illustrates an example of a fringe shift analysis at a number of different concentrations of a validation substance, known to bind to a target protein, not using the present method. For the results depicted in FIG. 23, the start and stop FT boundaries were established at signposts 1 and 6, respectively as depicted in FIG. 22A. As can be seen in the figure, the assay plot is relatively flat (indicating no detected binding) and the control plot shows some curvature, so that the end result (difference of assay and control plots) depicts a potential binding isotherm that is basically driven by the control group. As such this experiment does not detect any specific binding, suggesting that the signal analysis was not correctly established.

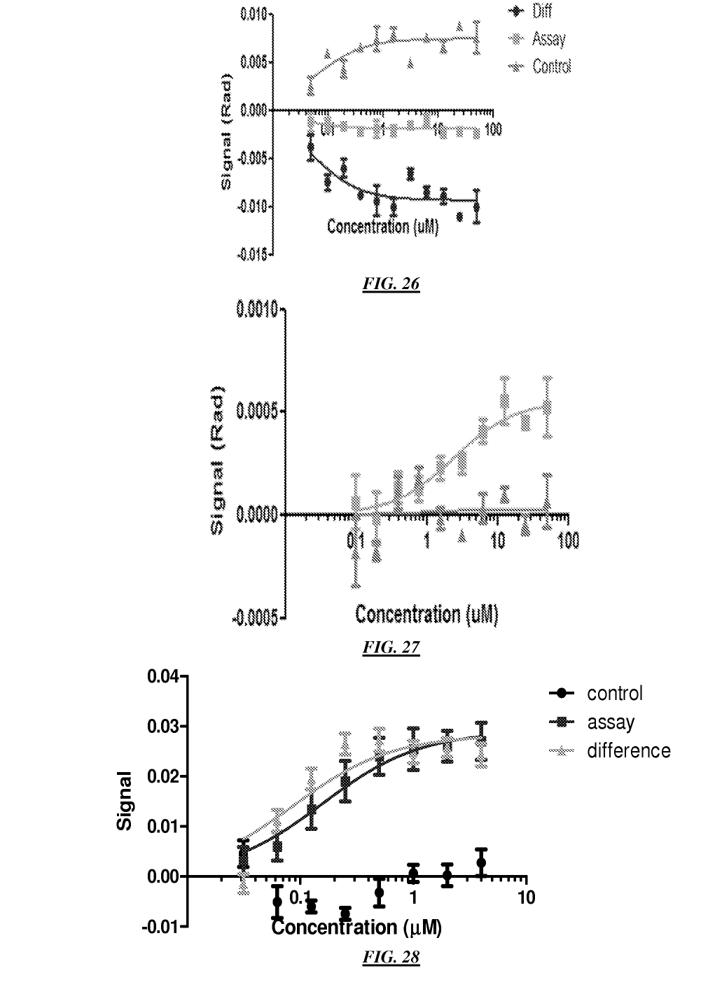

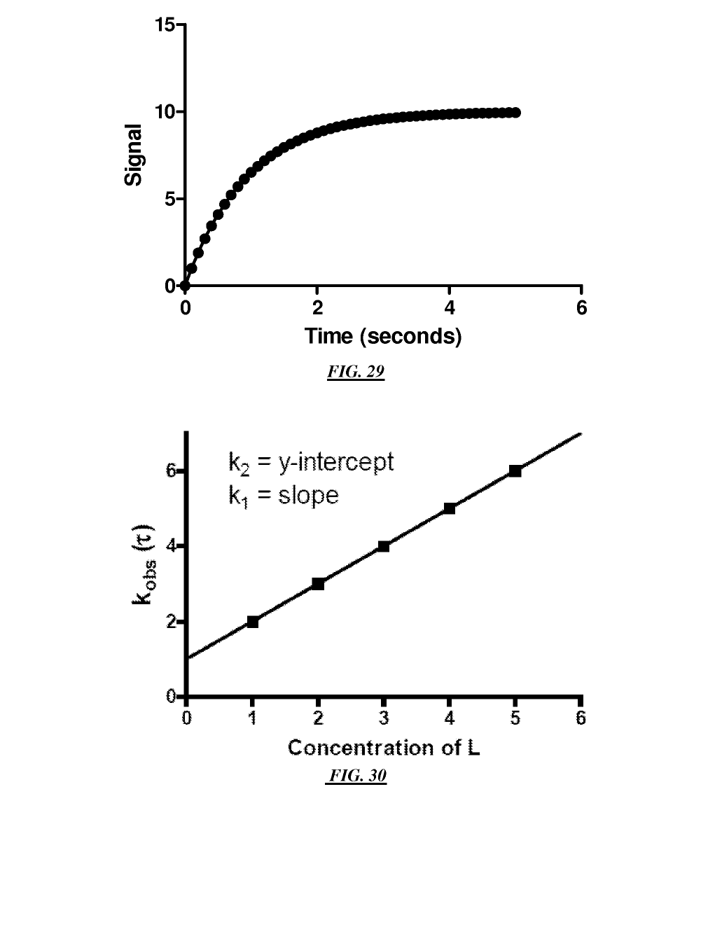

FIG. 27 illustrates the same fringe data using the method described herein to include boundary values in the FT analysis, as depicted in FIG. 22B. The method obtains a much improved signal for which the control is flat and the assay demonstrates the characteristic binding isotherm for a two-component biding event, indicating that the signal analysis was correctly established. In this analysis, a signal is produced that shows changes in phase as a function of concentration across a wide range of frequencies that are not shown in an analysis such as FIG. 26. Furthermore, it is possible to determine a concentration dependent phase for certain spatial frequencies, that strongly suggests the measured signal is true biding signal and not simply random noise or another signal which originates from some other source (thermal change, system injection noise, etc.). Thus, according to specific embodiments, fringe data from a BSI is analyzed using FT analysis and using partial peaks to obtain more sensitive and accurate binding curves.

In further embodiments, using a set of saved fringe patterns, the same data can be reprocessed with different start and stop locations. Using this method, it is possible to determine, identify, or visualize different frequencies that produce high signal of interest (e.g. binding signal) with significant signal to noise ratios. For example, previously stored fringe patterns can be systematically evaluated by dithering start and stop FT boundary conditions, while evaluating the resulting binding curves that would be created by the various iterations of fringe arrays and mathematical algorithms as subsequently described below. As such, these operations need not be performed in real time (during the analysis), and can be iteratively applied after the completion of the assay, leveraging electronically stored fringe patterns.

### Evaluation of Signal Processing Operations

As discussed above, according to specific embodiments, the present invention provides a method for analyzing BSI data that looks for changes in subportions of fringe patterns independently to detect events in complex systems. According to specific embodiments of the invention, a number of novel signal processing analysis or operations are disclosed, any one of which may independently provide improved detection of chemical event signal. In further embodiments, the invention performs two or more differing signal processing operations and evaluates those signal processing operations to determine which are selected to detect an event. These operations may differ in terms of which subportions of the data are evaluated and/or which particular form of signal processing operation is performed.

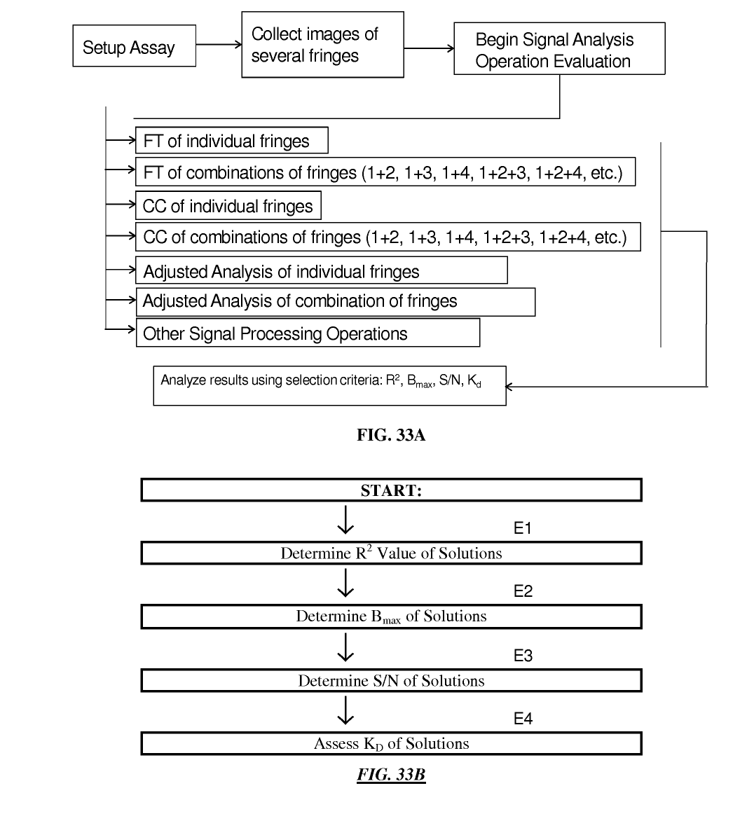

FIG. 33 A-B is a flow-chart illustrating performing different signal analysis methods on different portions of a fringe pattern and evaluating those different analysis methods to detect an event according to specific embodiments of the invention. According to specific embodiments of the invention, the evaluation of signal analysis methods evaluates different signal processing methods or operations performed on sub-portions or combinations of sub-portions of fringe pattern data and uses evaluation criteria to determine which signal processing method produces more sensitive and/or more accurate event signals. The evaluation is, to first order, related to the type of BSI assay being performed. As subsequently described in greater detail herein, BSI assays can be generally grouped for this discussion into four different varieties: homogeneous equilibrium (steady-state), homogeneous kinetic, heterogeneous steady-state, and heterogeneous kinetic. Moreover, these varieties can further be subdivided as binding assays or quantitative assays. As further detailed in FIG. 33B, a generalized evaluation that establishes the selection criteria for ultimate fringe and signal processing operation selection uses a hierarchical approach for which all solutions (combination of operations and fringes or parts thereof) are evaluated for:
1. Calculated coefficient of variation (R²) to determine if the measured signals provide an analytical plot that matches the requisite function as predicted by first principles of the assay type;
2. Bₘₐₓ values for a binding system for which superior results are directly proportional to Bₘₐₓ ranking;
3. Signal to noise (S/N) for each solution as defined as the slope of the response divided by the standard deviation of the signal or in some applications simply the standard deviation of replicate measurements. Preferred solutions are generally those with the greatest S/N, or the lowest standard deviation for replicate measurements;
4. K_{d} values for a binding system for which determined K_{d} must agree with first principle limits as dictated by the laws of mass action.

In some embodiments, this evaluation looks for the strongest overall change between a reference fringe pattern and a test fringe pattern. In other aspects, the invention evaluates signal processing operations by looking for those operations and sub-portions that provide a signal that most nearly matches or fits the concentration dependent, time dependent, or other response that would be expected for the particular reaction or event being detected. The overall approach to chemical event signal detection can be used with any number of different signal processing operations, including existing operations and novel operations as discussed herein. Thus, according to specific embodiments of the invention, a computer or other information processing system or device is configured to analyze fringe data according to various signal processing operations and also to determine which signal processing operations provide the desired detection for a particular event.

As will be further understood from the discussion herein, operation/fringe portion combination selection can be either qualitative or quantitative or both. Qualitatively, a combination can meet certain threshold criteria with respect to the four factors above. For example, a combination can be selected if the R² value is at least 0.5, if the Bₘₐₓ value is above a particular minimum dependent upon the binding system, and if the S/N is at least above an s/n threshold appropriate for the assay and if the K_{d} value agrees with first principles.

Quantitatively, when choosing between combinations, higher R² values, higher Bₘₐₓ values and higher S/N (or lowest standard deviation as noted above) values are generally preferred criteria.

According to specific embodiments of the invention, for particular types of BSI assays different evaluation parameters allow for the selection of the operation that produces the results that have better reproducibility and a stronger event signal. This allows for the direct comparison of different operations to select an operation and data subportion to provide a more sensitive binding signal.

In an example embodiment, a camera or similar capture device is setup so that it acquires generally multiple (e.g., at least two) fringes from the backscatter interferometry. In one example set up, a captured fringe pattern can be acquired at one second intervals during an assay (the procedure for each type of assay is described below). These fringe patterns are then analyzed with different signal processing operations (or methods or algorithms) using different portions of the fringe data. The output of each signal processing operation is then analyzed as described below to determine a most appropriate signal processing method for the type of experiment being run.

Analysis and evaluation for some reactions proceeds generally according to a law of mass action model as will be understood in the art. Such models often use known terms such as association rate constant (kₒₙ), dissociation rate constant (k_{off}) and equilibrium dissociation constant (K_{d}) where K_{d} is generally the ratio k_{off}/kₒₙ as parameters for characterizing a chemical reaction or molecular binding system and as parameters for evaluating data captured from such studies.

### Homogeneous Equilibrium Assay

For a homogeneous assay, the target concentration is setup, for example, at a fixed concentration of about 1/10 to 1 times an expected K_{d} and the ligand concentration is varied from about at least four times the expected K_{d} to at least 1/10 the expected K_{d}. The same ligand concentrations are setup with buffer as a control.

### Example 1

TABLE 1

| | |
|---|---|
| Expected K_{d} | 1 uM |
| Target Concentration | 100 nM |
| Ligand Concentrations | 4, 2, 1, 0.5, 0.25, 0.125, 0.0625, 0.031, 0.015, |
| | 0.007, 0 (“0” indicates a control or blank and is |
| | usually run) |

Using a program or software package (e.g., Prism™ from GraphPad Inc.), the signal versus concentrations is plotted for the control, assay, and difference. The difference plot is often more useful for further analysis as it removes the non-binding signal. FIG. 28 illustrates an example of a signal versus concentration data captured in order to analyze a signal processing operation according to specific embodiments of the invention.

Whatever statistical curve fitting method is used will generally fit a curve for a one site specific binding by the equation Y=Bₘₐₓ*X/(K_{d}+X). Such analysis software typically outputs parameters of Bₘₐₓ, K_{d}, Error for both, 95% confidence, and Goodness of Fit values (e.g., R²). These parameters and their use in statistical analysis are well understood in the field and explanation of their use is widely available.

Each of the evaluated signal processing operations is thus analyzed in general for goodness of fit or goodness of prediction of expected physical systems parameters (e.g., expected isotherms). Setting a cut-off parameter for the R² value is one method for eliminating an operation that is not producing a repeatable signal. One or more parameters (or figures of merit or selection criteria) are used to select the operation that will further be used to detect a binding event. As described below, in one example embodiment, a hierarchical process is employed for which each subsequent step is parsed but weighted successfully less than the previous step in the evaluation (or selection algorithm):
1. R² value (Generally, for example, <0.5 R² value is considered a non binder)
2. Bₘₐₓ (Bₘₐₓ generally varies based on the signal processing operation so it is generally only used to evaluate a given class or type of signal processing operation)
3. Signal to noise of the assay can be determined by ratio of Bₘₐₓ to the standard deviation (stdev) of all points (The higher the signal to noise ratio, the more confidence in the signal)
4. K_{d} that is determined (This can be used to eliminate an operation if the determined K_{d} is inconsistent with the expected range as predicted by first principles and the laws of mass action for the employed concentration of protein target and ligand concentration range.)

For example, according to specific embodiments, the invention selects the signal processing operation that produces the R² closest to 1, has the best Bₘₐₓ, with a signal to noise ratio that suggests that there is confidence in the signal, and a K_{d} in the expected range as dictated by the laws of mass action. The invention then uses the selected method for the event detection.

As a further example, consider a signal processing selection method run on three signal processing operations (a Fourier transform approach (FT), a cross-correlation approach (CC), and a CC adjusted by FT approach (A3)). As an example, the output of the operations evaluation in one example would produce results similar to the table below:

TABLE 2

| | FT | CC | A3 |
|---|---|---|---|
| Best fit | | | |
| Bmax | 0.028 | 0.27 | 100 |
| Kd | 0.085 | 0.087 | 0.101 |
| stderror | | | |
| Bmax | 0.0014 | 0.0015 | 15 |
| Kd | 0.021 | 0.02 | 0.05 |
| 95% confidence | | | |
| Bmax | .025-.031 | .24-.30 | 25-175 |
| Kd | .044-.132 | .046-.13 | .025-.19 |
| Goodness of fit | | | |
| Degrees of freedom | 34 | 34 | 34 |
| R2 | 0.81 | 0.84 | 0.67 |

In specific embodiments, the evaluation focuses on just a few key signal processing operation selection parameters, such as the parameters shown in Table 3.

TABLE 3

| | FT | CC | A3 |
|---|---|---|---|
| R2 | 0.81 | 0.84 | 0.67 |
| Bmax | 0.028 | 0.27 | 100 |
| Kd | 0.085 | 0.087 | 0.101 |
| S/N | 12.3 | 13.02 | 8.9 |

In this example both the FT and the CC show good R² values and produce very similar values for K_{d}. Thus, either of these signal processing operations should provide good event detection results and would be selected according to specific embodiments of the invention.

The above discussion shows a comparison of just three operations to provide a more easily understood description. However, according to specific embodiments of the invention, an automated reaction analysis system performs numerous different signal processing operations with numerous different sets of fringe data and cross-analyzes each of them. Thus, a table such as Table 2 or Table 3 in such a system may have parameters for hundreds of different signal processing operations and sub-portions, with individual computed values for R², Bₘₐₓ, K_{d} and S/N, and other parameters. An automated system according to specific embodiments thus includes logic configured for selecting one or more operations and data portions for event detection or quantitation.

As a further example, consider Table 4, which provides an example of operation selection process for a carbonic anhydrase and acetazolamide assay. The actual K_{d} of this assay was determined using other methods to be 0.31±0.06 uM. As shown in Table 4, in this example, R², S/N, Bₘₐₓ and K_{d} are used as criteria for the final selection of an operation and data subportion.

The invention in one example analysis first examines R² of each operation to determine if it is greater than a selection criteria, such as >0.5. If more than a particular number of the operations (e.g., 5, 7, 15, 25, or 50) pass this criterion, the invention can check the S/N of those operations. Again, a particular number of those (e.g., 5, 10, or 15) with the greatest S/N are selected for further evaluation. Then, Bₘₐₓ is used for selection. Generally, for each type of operation (for example, the three broad types: FT (Fast Fourier Transformation), CCF (Cross Correlation Function) and various notch filter (NF) transforms), the operations are scrutinized to determine the specific combination of fringe data and operation that produces the highest Bₘₐₓ value. Typically, the final part of the analysis is to select the operation that provides a K_{d} value or other reaction parameters that are closest to the expected parameters (e.g., the reference K_{d} value) or, for when expected parameters are not known, most readily comply with the predicted outcome as dictated by the laws of mass action and used concentrations of target and ligand.

TABLE 4

| Signal | | | | |
|---|---|---|---|---|
| Processing | | | | |
| Operation and | | | | |
| Fringe Data | R | | | |
| Subportion | square | S/N | Bₘₐₓ | K_{d}, uM |
| FT_1-5 | 0.64580 | 5.16235 | 0.00609 | 0.13270 |
| FT_1-4 | 0.3601 | 2.969349 | 0.003197 | 0.167 |
| FT_2-5 | 0.6792 | 5.255581 | 0.005768 | 0.2462 |
| FT_1-3 | 0.7866 | 6.497192 | 0.007808 | 0.1284 |
| FT_2-4 | 0.4815 | 3.271734 | 0.00329 | 0.4292 |
| FT_3-5 | 0.5988 | 4.60762 | 0.005159 | 0.267 |
| CCF_1-5 | 0.29860 | 2.71213 | 0.06030 | 0.19790 |
| CCF_1-4 | 0.05490 | 1.23374 | 0.02896 | 0.32180 |
| CCF_2-5 | 0.39200 | 3.16646 | 0.06998 | 0.29580 |
| CCF_1-3 | 0.70970 | 5.69335 | 0.13780 | 0.10830 |
| CCF_2-4 | 0.11560 | 1.45368 | 0.03393 | 0.56150 |
| CCF_3-5 | 0.01822 | 0.57983 | 0.01351 | 0.66330 |
| CCF_1-2 | 0.70660 | 5.60425 | 0.19080 | 0.14070 |
| CCF_2-3 | 0.83060 | 7.63729 | 0.19210 | 0.15400 |
| CCF_3-4 | 0.40010 | 2.83480 | −0.07566 | 0.07714 |
| CCF_4-5 | 0.16840 | 1.56951 | −0.03944 | 0.05573 |
| CCF _1 | 0.22130 | 1.79604 | 0.08789 | −0.00249 |
| CCF_2 | 0.88260 | 8.91111 | 0.48900 | 0.21230 |
| CCF_3 | 0.70340 | 5.81499 | 0.22530 | 0.13850 |
| CCF_4 | 0.75540 | 6.41733 | −0.24860 | 0.08574 |
| CCF_5 | 0.90160 | 11.00478 | 0.58770 | 0.16410 |
| CCF_Sum_All | 0.66270 | 5.31992 | 0.01428 | 0.16720 |
| Notch-filter | 0.78450 | 5.14462 | −0.00208 | 0.11590 |
| (NF)1 one | | | | |
| NF2 | 0.94930 | 12.93519 | 0.00423 | 0.30920 |
| NF3 | 0.53710 | 3.84970 | 0.00089 | 0.26960 |
| NF4 | 0.97150 | 17.68294 | −0.00594 | 0.08729 |
| NF5 | 0.95700 | 15.81674 | 0.00621 | 0.18150 |
| NF6 | 0.81450 | 8.52969 | 0.00911 | 0.00636 |
| | | | The highest | Compare |
| | | | of each | the Kd |
| | | | type of | with reference |
| | R² > 0.5 | top 5 | algorithm | Kd |

Table 4 further illustrates, as discussed above, that a number of different subportions of data may be evaluated along with associated operations according to different criteria. In this table, three different operations as discussed above are compared, as indicated in the left most column: FT (Fast Fourier Transformation), CCF (Cross Correlation Function) and notch filter (NF) transforms. For each comparison in this example, various sub-portions of the fringe data are used for analysis. The numbers in the left column indicate the different portions of the fringe data used. In this particular example, five fringes are captured from the fringe data (such as five adjacent or non-adjacent fringes selected from the overall fringe data such as the example illustrated in FIG. 2) and are assigned numbers from 1 to 5. Different sets of these fringes are indicated in the column such as FT_{—}2-5 indicating an example fast Fourier transform operations performed on fringes 2, 3, 4, and 5, or CCF_{—}2 indicating a cross correlation performed using just the second of the five captured fringes.

While this example shows comparisons of particular subportions defined according to spatial fringe data and performed on adjacent fringes, it will be understood that sub-portions of data selected according to frequency criteria can also be used as described herein.

### Homogeneous Kinetic Assay

Kinetic assays are BSI assays that are used to detect how quickly chemical events proceed under various conditions. Typically, in such assays, the concentrations of the analyte and the ligand are known and the BSI assay is used to determine reaction speed. As discussed above, different signal processing operations may provide better results for different concentrations. In selecting a signal processing operation for these assays, for each concentration the signal is plotted vs. time. The kinetic association rate for a one-site binding system is determined using the equation: Y=Ymax*(1−exp(−1*kob*X)). In some situations, it is presumed or is in fact the case that the reaction or chemical event proceeds throughout the sample in roughly the same way, in which case these assays are referred to as homogeneous because essentially the changing bulk RI is what is detected.

Signal processing operation parameters for determining which operation provides the best results are similar to those used for the homogeneous equilibrium assay provided above. Generally, signal processing operations are evaluated for various concentrations, as provided in the examples below.

### Concentration 1

TABLE 5

| | FT | CC | A3 |
|---|---|---|---|
| R2 | 0.79 | 0.82 | 0.81 |
| Bmax | 0.012 | 0.105 | 15 |
| Kobs | 2.02 | 2.1 | 2.03 |
| S/N | 18.8 | 20 | 19.2 |

### Concentration 2

TABLE 6

| | FT | CC | A3 |
|---|---|---|---|
| R2 | 0.82 | 0.9 | 0.78 |
| Bmax | 0.025 | 0.21 | 31 |
| Kobs | 3.5 | 3.1 | 3 |
| S/N | 27 | 30 | 25 |

The signal processing operation chosen may be determined for every concentration. In the example above, the CC has the higher R² and S/N ratio. In this example, the Bₘₐₓ is hard to compare between different types of operations and is not used for comparing the different types of operations but may be used for comparing variations on the CC operation. As the Kobs is similar between all three operations (in this example), that would not be an important evaluation criteria.

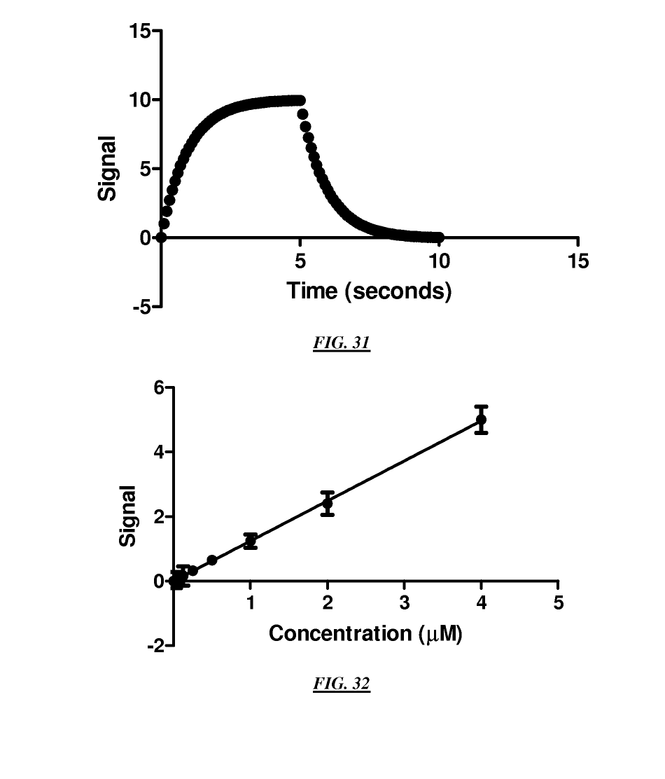

The Kobs and the concentrations provide the linear plot as shown in FIG. 30. The fit for a linear response is the R², slope, and the S/N (slope/average standard deviation of the points). As this data is calculated from the selection parameters above, the first approximation (in this example the CC) will most likely give the best response. However in the automatic operation evaluation will compare the different operations.

TABLE 7

| | FT | CC | A3 |
|---|---|---|---|
| R2 | 0.89 | 0.92 | 0.85 |
| Slope | 0.098 | 1.01 | 0.85 |
| S/N | 10 | 12 | 8 |

### Heterogeneous Equilibrium Assay

In the examples described herein, this analysis proceeds as with the Homogeneous Equilibrium Assay

### Heterogeneous Kinetic Assay

The heterogeneous kinetic assay proceeds above as does the homogeneous kinetic assay, but in some instances it is also desirable to determine kₒₙ and k_{off}.

More recent versions of analysis tools (e.g., Prism) allow calculation of the association (upward part of the curve) and dissociation (downward part of the curve) simultaneously (or separately). An example set of parameters are provided in the table below.

TABLE 8
Simultaneous analysis:

kob = [ligand]*kon+koff
K_{d} = koff/kon
Eq = Bₘₐₓ*ligand/(ligand + K_{d})
Association = Eq*(1−exp(−1*kob*X))
YatTime0 = Eq*(1−exp(−1*kob*Time0))
Dissociation = YatTime0*exp(−1*koff*(X-Time0))
Y = IF(X<Time0, Association, Dissociation) + NS

For the Association and Dissociation split the association kinetic one concentration binder using the equation: Y=Ymax*(1−exp(−1*kob*X)). This proceeds as for the homogeneous kinetic assay.

For the dissociation. Y=(Y0−NS)*exp(−K*X)+NS. NS: binding at very long times, in units of Y. The Parameters are R² and S/N. Example (simultaneous):

TABLE 9

| | FT | CC | A3 |
|---|---|---|---|
| R2 | 0.86 | 0.89 | 0.87 |
| S/N | 11 | 14 | 12 |
| Kon | 2 | 2.05 | 3 |
| Koff | 1 | 1.01 | 2 |
| Kd | 0.5 | 0.492683 | 0.666667 |
| Bmax | 0.05 | 0.5 | 25 |

This calculation, as above, may be determined for every concentration of ligand ran, thus a final parameter, the variation of K_{d} is determined for each operation

TABLE 10

| | FT | CC | A3 |
|---|---|---|---|
| Kd | 0.52 | 0.5 | 0.7 |
| St. Dev. | 0.02 | 0.005 | 0.03 |

Thus the operation with the lowest standard deviation of K_{d} calculated (CC in this example) would be the operation selected.

An alternative approach to this last step is to use a global fitting program that would fit every concentration of ligand simultaneously to determine the best parameters overall. Similar R² and S/N ratio could be used to determine the best operation in that case.

### Quantitative Analysis

The quantitative analysis assay is setup so that the target is in excess of the ligand and the ligand is varied in concentration. In one example embodiment, the evaluation module determines a signal processing operation by selecting for a good R², maximized slope, and high S/N.

TABLE 11

| | FT | CC | A3 |
|---|---|---|---|
| R2 | 0.91 | 0.92 | 0.87 |
| Slope | 0.1 | 1.1 | 60 |
| S/N | 19 | 20 | 17 |

The slope can again only be used within a given operation. The R² and the S/N are the two parameters that will be used to determine which operation produces the best results. (As the purpose of the quantitative assay is to see how low a signal can be accurately determined, the S/N might be the better method for operation determination).

### Tuning Optical Parameters

According to specific embodiments of the present invention, improved chemical event detection is accomplished with improved analysis and without requiring any modifications to the physical optical train of a BSI system. However, according to further embodiments, methods for analyzing BSI fringe data as described herein are used to first identify one or more portions of the fringe data as containing the majority of the binding signal, and then, via an iterative process, fine tune the optical parameters of the BSI device to maximize assay signal and fidelity.

In specific embodiments, this is accomplished by (a) repeating the assays in total or simply repeating a series of measurements comparing Bₘᵢₙ (control system or ligand concentration that is way below detection dynamic range) with Bₘₐₓ signals while adjusting one or more of the following optical parameters: (i) angle of incidence of laser to the channel (ii) angle of incidence of the fringe pattern to the camera.

The invention then uses an optical alignment algorithm that dithers adjusted parameters such as (i) and (ii) above, as will be generally understood in the art and from herein referenced publications, and applies the methodologies discussed above to explore optical alignment parameters to insure maximized performance prior to initial experimentation.

### Drug Screening and Drug Discovery

A first and second biochemical species and whether the first and second biochemical species interact with one another can be monitored by monitoring the change in refractive index of the liquid. In some instances, the first and second biochemical species are selected from the group comprising complimentary strands of DNA, DNA-RNA compliments, DNA-protein pairs, RNA-protein pairs, complimentary proteins, drug molecule-receptor pairs, ligand-receptor pairs, and antibody-antigen pairs, and lectin-carbohydrate pairs. Methods herein can provide monitoring of whether a ligand in a liquid binds with one or more receptors by monitoring the change in refractive index of the liquid. In another embodiment, a method can comprise analyzing a label-free hybridization reaction in a liquid by analyzing the change in refractive index of the liquid. Analyzing a chemical or enzymatic reaction between two or more molecules can be completed by monitoring the change in refractive index of a liquid. In an embodiment, a method provides analyzing a structural or conformational change of a molecule by monitoring the change in refractive index of a liquid. In an embodiment, a method provides a means of quantitating or quantifying the amount of a target compound by monitoring the change in refractive index of a liquid that contains the target compound and it's binding cognate.

According to specific embodiments, the present invention can be used in various chemical screening or drug screening operations to determine whether there is a binding or reaction involving a substance (e.g., molecules, or analyte, or moieties A to B) and the strength of that binding or reaction or interaction. Various assays are well known in the art, particularly in the art of drug discovery. For example, when analyzing the binding of analyte or moiety A to analyte or moiety B, an assay may be initiated with a plurality of concentrations of A and constant concentrations of B and measurements performed at each different concentration of A. The assay may be designed to determine if there is binding between A and B and how strong (often expressed by determining a value for K_{d}) is that binding. Determining an accurate measure of K_{d} is thus a very important tool in screening for such things as activity of various drug candidates as well as for toxicity screening.

An assay may also be designed to determine the presence of B, which is at times referred to as a quantitative assay. For this assay, in some example set ups, a constant or enabling level of A is introduced with an unknown level of B. The assay determines if there is any B present or how much B is present by detecting how much AB is formed. In such assays, there are typically calibration kits used that for example would contain different known concentrations of B.

In one such example assay, a drug target B might be tested with 100 different new drugs A₁₋₁₀₀. Target B is typically provided in a sample at sparingly low concentrations near a target K_{d} of importance. For example, if a target K_{d} is 100 nM, B is provided at 10-100 nM. Typically, a dose response series is created for each A, ranging from ⅕ to 5× the concentration of B, with a plurality of points (e.g., e.g., 7, 8, or 10) in between.

In such an assay, the ultimate answer being sought is generally of the form of determining the K_{d} of the interaction. Generally, a combination is determined that provides the best saturation isotherm and from that is determined Bₘₐₓ and K_{d}. Determining an accurate K_{d} has remained difficult in many drug screening situations and the present invention, according to specific embodiments, provides a system to improve drug screening.

As will be further understood and as discussed above, the present invention in specific embodiments can be part of a back-scattering interferometer according to specific embodiments of the invention. A back-scattering interferometer typically comprises an optical assembly and electronics to analyze an optical signal. The optical assembly can be mounted on an optical bench. Back-scattering interferometers are well known in the art. Back-scattering interferometers and their use are described, for example, in U.S. Pat. Nos. 5,325,170; 6,381,925; 6,381,025; 6,809,828, 7,130,060, and 8,120,777; International applications WO 2004/023115, WO 2006/047408 and WO 2009/039466; and U.S. patent publications U.S. 2010/0099203 (Chang et al.), 2010/0184056 (Weinberger et al.) and 2010/0188665 (Dotson et al.). It will be apparent to those of skill in the art that the present invention can be utilized in a wide range of BSI systems, such as those described in all references cited herein.

### Programmed Information Appliance and Other Embodiments

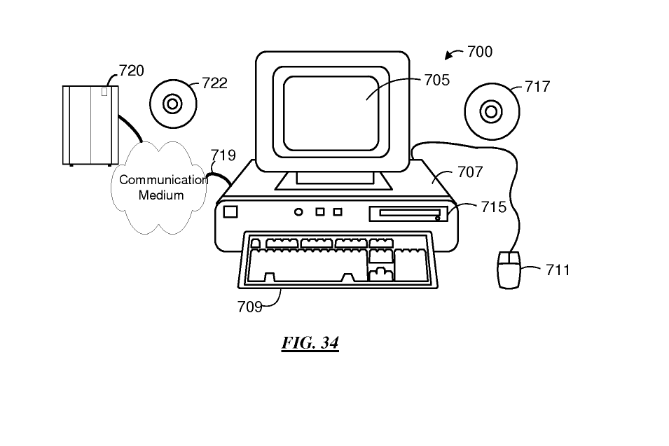

FIG. 34 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component. As used herein, the terms “configured for” or “configured to” when applied to a logic module or device shall be understood to include systems or device configured to perform or for performing a described operation, whether that performing is done or accomplished or enabled in any particular device or system.

FIG. 34 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705, which can be used to display various tables, graphs, and other data and/or interfaces as described herein. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

Thus, specific compositions and methods of IMPROVED EVENT DETECTION FOR BACK-SCATTERING INTERFEROMETRY have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The general structure and techniques, and more specific embodiments that can be used to effect different ways of carrying out the more general goals are described herein. Although only a few embodiments have been disclosed in detail above, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative that might be predictable to a person having ordinary skill in the art.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation or laboratory or manufacturing equipment. The computer may be an Intel (e.g., Pentium or Core 2 duo) or AMD based computer, running Windows XP or Linux, or may be a Macintosh computer. The computer may also be a handheld computer, such as a PDA, cellphone, or laptop, running any available operating system, including Android, Windows Mobile, iOS, etc.

The programs may be written in C, Python, Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium, or other removable medium. The programs may also be run over a network, for example, with a server or other machine sending signals to the local machine, which allows the local machine to carry out the operations described herein.

What is claimed:

1. A system for detecting a chemical event comprising:
a logic module for analyzing sub-portions of at least two interferometric fringe patterns using a signal processing operation, the at least two fringe patterns each comprising a plurality of fringes;
the logic module configured for selecting one or more of the sub-portions that change between the two sets of fringes;
wherein a change indicates a chemical event.

2. The system according to claim 1 wherein the logic module is further configured to use the selected sub-portions to output a signal indicative of a chemical event.

3. The system according to claim 1 wherein one or more of the sub-portions is identified as changing in response to a chemical event of interest and further wherein the logic module is configured for determining an occurrence of a chemical event of interest by analyzing a fringe shift of the sub-portions.

4. The system according to claim 1 wherein the signal processing comprises Fourier transformation (FT) of individual fringes or parts of individual fringes.

5. The system according to claim 1 wherein the signal processing comprises FT of combinations of fringes or parts of fringes.

6. The system according to claim 1 wherein the signal processing comprises FT analysis of one or more subdominant frequencies.

7. The system according to claim 1 wherein the signal processing comprises repeated FT analysis of the fringe pattern changing the boundary conditions to include partial fringes to the left or the right of full wavelength fringes and evaluating the results to chose the best FT boundary conditions for detecting the chemical event.

8. The system according to claim 1 wherein the signal processing comprises notch filter processed fringes or parts of fringes.

9. The system according to claim 1 wherein the signal processing comprises cross correlation (CC) of individual fringes or parts of fringes.

10. The system according to claim 1 wherein the signal processing comprises CC of combinations of fringes (e.g., 1&2, 2&3, 3&4, 1&2&3, 1&2&3&4, etc.).

11. The system according to claim 1 wherein the signal processing comprises CC of individual fringes or parts of fringes summed (1+2, 1+3, 1+4, 2+3, 2+4, etc.)

12. The system according to claim 1 wherein the signal processing comprises CC adjusted by FT of individual fringes.

13. The system according to claim 1 wherein the signal processing comprises CC adjusted by FT of combination of fringes.

14. The system according to claim 1 wherein:
the signal processing operation is selected from the group comprising:
Fourier transformation (FT) of individual fringes or parts of individual fringes;
FT of combinations of fringes or parts of fringes;
FT analysis of one or more subdominant frequencies;
repeated FT analysis of the fringe pattern changing the boundary conditions to include partial fringes to the left or the right of full wavelength fringes and evaluating the results to chose the best FT boundary conditions for detecting the chemical event;
notch filter processed fringes or parts of fringes;
cross correlation (CC) of individual fringes or parts of fringes;
CC of combinations of fringes (e.g., 1&2, 2&3, 3&4, 1&2&3, 1&2&3&4, etc.);
CC of individual fringes or parts of fringes summed (1+2, 1+3, 1+4, 2+3, 2+4, etc.)
CC adjusted by FT of individual fringes; and
CC adjusted by FT of combination of fringes.

15. The system according to claim 1 further comprising:
the logic module configured for selecting a signal processing operation and one or more sub-portions of the fringe patterns for detecting a particular chemical event by:
performing two or more operations on fringe patterns from a possible occurrence of a chemical event;
comparatively evaluating the detection results of the two or more operations; and
selecting a signal processing operation for determining an occurrence of a chemical event of interest.

16. The system according to claim 15 further wherein:
the possible occurrence of a chemical event is a previously known and characterized chemical event run during a calibration.

17. The system according to claim 15 further wherein:
the possible occurrence of a chemical event is not a previously known and characterized chemical event thereby providing an at least partially self-calibrating assay.

18. The system according to claim 1 further comprising:
at least one adjustable portion of an optical train that is adjustable to more precisely capture one or more of the subportions;
the logic module configured for outputting an indication of which subportions change in response to a chemical event of interest; and
wherein the output indication of which subportions change in response to a chemical event of interest is used to adjust the at least one portion of the optical train.

19. The system according to claim 15 further wherein:
the signal processing operations are one or more selected from the group comprising of:
Fourier transformation (FT) of individual fringes or parts of individual fringes;
FT of combinations of fringes or parts of fringes;
FT analysis of one or more subdominant frequencies;
repeated FT analysis of the fringe pattern while changing FT boundary conditions to include partial fringes to left or right of full wavelength fringes and evaluating the results to chose the best FT boundary conditions for detecting the chemical event;
notch filter processed fringes or parts of fringes;
cross correlation (CC) of individual fringes or parts of fringes;
CC of combinations of fringes (e.g., 1&2, 2&3, 3&4, 1&2&3, 1&2&3&4, etc.);
CC of individual fringes or parts of fringes summed (e.g., 1+2, 1+3, 1+4, 2+3, 2+4, etc.) CC adjusted by FT of individual fringes; and
CC adjusted by FT of combination of fringes.

20. The system according to claim 15 further wherein:
at least one of the two or more signal processing operations comprise:
an adjustment algorithm and fringe subportion combination that provides a parameter or value or output used to adjust an adjusted signal processing operation and fringe subportion combination.

21. The system according to claim 15 further wherein:
the two or more signal processing operations comprise a plurality of operation/fringe subportion combinations;
the comparatively evaluating comprises identifying at least one combination satisfying one or more statistical or chemical reaction criteria.

22. The system according to claim 21 further wherein the one or more statistical or chemical reaction criteria are selected from the group consisting of:
R² value is at least about 0.5;
a K_{d} that satisfies expected chemical reaction principles.

23. The system according to claim 21 further wherein when a plurality of combinations meet said criteria, selecting a combination in which at least one of said criteria is greater than criteria in another combination.

24. The system according to claim 21 further wherein when a plurality of combinations meet said criteria, selecting a combination in which at least one of R², binding max and signal-to-noise ratio is greater than R², binding max or signal-to-noise ratio in another combination.

25. The system according to claim 21 further wherein when a plurality of combinations meet said criteria, selecting a combination by considering two or more criteria in combination.

26. The system according to claim 21 further wherein when a plurality of combinations meet said criteria, selecting a combination by considering two or more criteria according to a priority indicating which criteria is most important for said selecting.

27. The system according to claim 1 further wherein:
the sub-portions selected are those that are more influenced by refractive changes due to the chemical event of interest than by refractive changes due to bulk effects.

28. The system according to claim 1 further wherein:
the sub-portions selected are those that are more influenced by refractive changes due to the chemical event of interest than by refractive changes due to increasing concentrations of an introduced substance.

29. The system according to claim 1 further wherein the sub-portions are two or more fringes that are not adjacent.

30. The system according to claim 1 further wherein the sub-portions are one or more spatial frequencies of the fringe patterns.

31. The system according to claim 1 further wherein the sub-portions are one or more minor spatial frequency modes of the fringe patterns.

32. The system according to claim 1 further wherein the sub-portions are one or more selected from the group consisting of:
individual fringes;
portions of fringes;
contiguous and non-contiguous sets of individual fringes and/or portions of fringes;
portions of fringe data defined by pixel-capture region, such as vertical and horizontal slices of the fringe data;
any combination of fringe data selected by one or more criteria in the frequency domain (e.g., via Fourier transform and/or frequency domain filtering);
results of any operation using any subportions, the operation being various mathematical or signal processing functions such as summing, filtering, weighted combinations, etc.

33. The system according to claim 1 further wherein analyzing sub-portions of at least two interferometric fringe patterns comprises:
subtracting a reference fringe pattern from a captured fringe pattern to determine a difference pattern and analyzing the difference pattern.

34. The system according to claim 1 further wherein analyzing sub-portions of at least two interferometric fringe patterns comprises:
subtracting a reference fringe pattern from a captured fringe pattern to determine a difference pattern;
performing a Fourier transform on the difference pattern to determine amplitudes of frequency components of the difference pattern;
detecting a chemical event from a change in amplitude of one or more frequencies.

35. The system according to claim 1 further wherein analyzing sub-portions of at least two interferometric fringe patterns comprises:
subtracting a reference fringe pattern from a captured fringe pattern to determine a difference pattern;
summing the differences between the minima and the maxima of one or more cycles (or fringes) of the difference pattern to detect a chemical event.

36. The system according to claim 1 further wherein analyzing sub-portions of at least two interferometric fringe patterns comprises:
summing the differences between the minima and the maxima of one or more fringes of the reference pattern and the fringe pattern and detecting a chemical event from fringes with the largest differences.

37. The system according to claim 1 further wherein:
the analyzing is performed on a plurality of fringes of captured experimental data and the subportions of fringe patterns are not determined a priori for a particular system configuration.

38. The method according to claim 1 further wherein:
the analyzing examines fringes outside or a region of spatial frequency uniformity of the fringe pattern.

39. The system according to claim 1 further wherein:
the analyzing uses fringe data outside of a dominant fringe spatial frequency to correlate fringes.

40. The system according to claim 1 further wherein analyzing sub-portions of at least two interferometric fringe patterns comprises:
performing individual cross-correlation analyses upon a plurality of fringes; and
summing the resulting change in fringe position as a composite signal;
thereby simultaneously interrogated a plurality of fringes using cross correlation, allowing for the monitoring of BSI chemical event signal irrespective of to which fringes the binding signal is distributed.

41. The system according to claim 1 further wherein analyzing sub-portions of at least two interferometric fringe patterns comprises:
performing a plurality of FT analysis to a sliding window of fringes; and
summing the resulting change in fringe position.

42. The system according to claim 1 further wherein analyzing sub-portions of at least two interferometric fringe patterns comprises:
performing a forward FT to employ filters in the frequency domain and a reverse FT to return to the spatial domain to interrogate a given domain for one or more fringes within a given experiment; and
analyzing the output signal as either individual components or a sum.

43. The system according to claim 1 further wherein the analyzing sub-portions of at least two interferometric fringe patterns comprises:
applying one or more other filters for frequency and spatial domains.

44. The system according to claim 1 further wherein the analyzing sub-portions of at least two interferometric fringe patterns comprises:
applying one or more other filters for frequency and spatial domains, the filters including but not limited to: discrete cosine transform, spatial filters (low pass, band pass, high pass filtering), weighted average filters, Hartley transform, La Place filters, differential axis filters, and Wiener filters.

45. The system according to claim 1 further wherein the chemical event is one or more events selected from the group consisting of: binding, protein folding, cleavage, unbinding, or any chemical or biological change in a sample or portions of a sample that causes a detectable back scattering interferometry (BSI) fringe shift.

46. The system according to claim 1 further wherein the chemical event is one or more interaction events between moieties selected from the group consisting of: protein-protein, antibody-antigen, protein-small molecule or drug, protein-ion, protein-carbohydrate, protein-lipid, protein-nucleic acid, protein-DNA, protein-RNA, lipid-lipid, DNA hybridization, DNA-RNA binding, binding to molecular mimetics such as molecular imprints (MIP); binding to membrane bound proteins, binding to biomolecules immobilized or associated with nanoparticles, binding to biomolecules or molecules embedded in cell membrane-like structures or mimetics (lipoparticles, liposomes, unilamellar vessicels of varying size, nanodiscs).

47. The system according to claim 1 further comprising:
a substrate holder configured for receiving a substrate having a compartment formed therein for reception of a liquid;
an optical train configured for directing a coherent light beam onto the substrate such that the light beam is incident on the compartment containing the liquid to generate backscattered light; and
a detector configured for detecting the backscattered light, wherein the backscattered light comprises a fringe pattern whose position may shift in response to changes in the refractive index of the liquid.

48. The system according to claim 47 wherein the detector is a photo detector having a pixel resolution.

49. The system according to claim 47 wherein the coherent light beam is a laser.

50. The system according to claim 47 wherein the laser has a diameter of 2 mm or less.

51. The system according to claim 1 further wherein the chemical event is one or more events selected from the group consisting of: (a) an interaction between a first and second biochemical species; (b) a ligand in the liquid binds with one or more receptors (c) a label-free hybridization reaction; (d) a chemical or enzymatic reaction between two or more molecules; and (e) a structural or conformational change of a molecule by monitoring the change in refractive index of the liquid.

52. The system according to claim 51 further wherein the first and second biochemical species are selected from the group comprising complimentary strands of DNA, complimentary proteins and antibody-antigen pairs.

53. A computer readable tangible medium containing computer interpretable instructions describing a circuit layout for an integrated circuit that, when constructed according to the descriptions, will configure a circuit to embody the system described in claim 1.

54. A computer readable tangible medium containing computer interpretable logic instructions that, when loaded into an appropriately configured logic system, will configure the logic system to embody the system described in claim 1.

55. The system according to claim 1 further comprising any combination of any of the elements of claims 2 through 54.

56. A method of providing an improved interferometric detector comprising:
capturing a time series of two or more fringe patterns from a back scattered system;
wherein each fringe pattern comprises a plurality of fringes;
comparing a plurality of individual fringes or subportions of fringes or both at different times in the time series to determine two or more fringes useful for detecting the binding event;
configuring the detector to determine the fringe shift of the selected fringes thereby determining the binding event.

57. A method of providing an improved interferometric detector comprising:
selecting an operation and fringe subportion combination for detecting chemical events by providing a plurality of operation/fringe subportion combinations and identifying at least one combination satisfying one or more statistical or chemical reaction criteria;
configuring the detector to measure fringe shift using the selected combination.

58. The method according to claim 57 further wherein the one or more statistical or chemical reaction criteria are selected from the group consisting of:
R² value is at least about 0.5;
a K_{d} that satisfies expected chemical reaction principles.

59. The method according to claim 57 further wherein when a plurality of combinations meet said criteria, selecting a combination in which at least one of said criteria is greater that criteria in another combination.

60. The method according to claim 57 further wherein when a plurality of combinations meet said criteria, selecting a combination in which at least one of R², binding max and signal-to-noise ratio is greater than R², binding max or signal-to-noise ratio in another combination.

61. The method according to claim 57 further wherein when a plurality of combinations meet said criteria, selecting a combination by considering two or more criteria in combination.

62. The method according to claim 57 further wherein when a plurality of combinations meet said criteria, selecting a combination by considering two or more criteria according to a priority indicating which criteria is most important for said selecting.

63. The method according to claim 57 further comprising any combination of any of the elements of claims 2 through 54.

64. A system for detecting a chemical event comprising:
a capture logic module for receiving or capturing at least two fringe patterns, each fringe pattern comprising a plurality of subportions;
a signal processing operations module for applying two or more varying signal processing operations, the varying operations varying as to the combinations of subportions used, the type of signal processing operation or both;
an evaluation module for evaluating results of the signal processing operations module to determine a signal processing operation and subportion to use to detect a change between the at least two fringe patterns that indicates a chemical event; and
an output module for outputting a signal indicative of an event.

65. The system according to claim 64 wherein one or more of the sub-portions is identified as changing in response to a chemical event of interest and further wherein the logic module is configured for determining an occurrence of a chemical event of interest by analyzing a fringe shift of the sub-portions.

66. The system according to claim 64 further wherein:
the possible occurrence of a chemical event is a previously known and characterized chemical event run during a calibration.

67. The system according to claim 64 further wherein:
the possible occurrence of a chemical event is not a previously known and characterized chemical event thereby providing an at least partially self-calibrating assay.

68. The system according to claim 64 further comprising:
at least one adjustable portion of an optical train that is adjustable to more precisely capture one or more of the subportions;
the logic module configured for outputting an indication of which subportions change in response to a chemical event of interest; and
wherein the output indication of which subportions change in response to a chemical event of interest is used to adjust the at least one portion of the optical train.

69. The system according to claim 64 further wherein:
the operations are one or more selected from the group comprising of:
Fourier transformation (FT) of individual fringes or parts of individual fringes;
FT of combinations of fringes or parts of fringes;
FT of one or more subdominant frequencies;
repeated FT analysis of the fringe pattern changing the boundary conditions to include partial fringes to the left or the right of full wavelength fringes and evaluating the results to chose the best FT boundary conditions for detecting the chemical event;
notch filter processed fringes or parts of fringes;
cross correlation (CC) of individual fringes or parts of fringes;
CC of combinations of fringes (e.g., 1&2, 2&3, 3&4, 1&2&3, 1&2&3&4, etc.);
CC of individual fringes or parts of fringes summed (1+2, 1+3, 1+4, 2+3, 2+4, etc.)
CC adjusted by FT of individual fringes; and
CC adjusted by FT of combination of fringes.

70. The system according to claim 64 wherein the signal processing comprises Fourier transformation (FT) of individual fringes or parts of individual fringes.

71. The system according to claim 64 wherein the signal processing comprises FT of combinations of fringes or parts of fringes.

72. The system according to claim 64 wherein the signal processing comprises FT analysis of one or more subdominant frequencies.

73. The system according to claim 64 wherein the signal processing comprises repeated FT analysis of the fringe pattern changing the boundary conditions to include partial fringes to the left or the right of full wavelength fringes and evaluating the results to chose the best FT boundary conditions for detecting the chemical event.

74. The system according to claim 64 wherein the signal processing comprises notch filter processed fringes or parts of fringes.

75. The system according to claim 64 wherein the signal processing comprises cross correlation (CC) of individual fringes or parts of fringes.

76. The system according to claim 64 wherein the signal processing comprises CC of combinations of fringes (e.g., 1&2, 2&3, 3&4, 1&2&3, 1&2&3&4, etc.).

77. The system according to claim 64 wherein the signal processing comprises CC of individual fringes or parts of fringes summed (1+2, 1+3, 1+4, 2+3, 2+4, etc.)

78. The system according to claim 64 wherein the signal processing comprises CC adjusted by FT of individual fringes.

79. The system according to claim 64 wherein the signal processing comprises CC adjusted by FT of combination of fringes.

80. The system according to claim 64 further wherein at least one of the two or more signal processing operations comprise an adjustment algorithm and fringe subportion combination that provides a parameter or value or output used to adjust an adjusted signal processing operation and fringe subportion combination.

81. The system according to claim 64 further wherein the two or more operations comprise a plurality of operation/fringe subportion combinations and the comparatively evaluating comprises identifying at least one combination satisfying one or more statistical or chemical reaction criteria.

82. The system according to claim 64 further wherein the sub-portions are one or more minor spatial frequency modes of the fringe patterns.

83. The system according to claim 64 further wherein the chemical event is one or more events selected from the group consisting of: (a) an interaction between a first and second biochemical species; (b) a ligand in the liquid binds with one or more receptors (c) a label-free hybridization reaction; (d) a chemical or enzymatic reaction between two or more molecules; and (e) a structural or conformational change of a molecule by monitoring the change in refractive index of the liquid.

84. A computer readable tangible medium containing computer interpretable logic instructions that, when loaded into an appropriately configured logic system, will configure the logic system to embody the system described in claim 64.

85. The system according to claim 64 further comprising any combination of any of the elements of claims 65 to 84.

86. The system according to claim 64 further comprising any combination of any of the elements of claims 2 to 54 or 65 to 84.

87. A system for detecting an event from signal data comprising:
a capture logic module for receiving or capturing at least two signal data patterns, each pattern comprising a plurality of subportions;
a signal processing operations module for applying two or more varying signal processing operations, the varying operations varying as to the combinations of subportions used, the type of signal processing operation, or both;
an evaluation module for evaluating results of the signal processing operations module to determine a signal processing operation and subportion to use to detect a change between the at least two patterns that indicates an event; and
an output module for communicating occurrence of the event or the results of the signal processing operations module or the results of the evaluation module or any combination thereof to a user.

88. The system according to claim 87 further comprising:
an adjustment module for selecting and applying an operation and subportion combination that provides a parameter or value or output used to adjust an adjusted signal processing operation and fringe subportion combination.

89. The system according to claim 88 further wherein:
the evaluation module selects an adjustment algorithm and subportion that detects correlated noise and uses the results to isolate that noise from the signal of interest.

90. A method of providing an improved interferometric detector comprising:
analyzing a plurality of sub-portions of at least two fringe patterns using one or more signal processing operations;
automatically evaluating results of the analyzing to select an operation and subportion combination that provide a signal in response to the binding event; and
configuring the detector to measure fringe shift using the selected combination.

91. The method according to claim 90 further comprising:
adjusting an adjustable portion of the detector to more precisely capture one or more of the subportions indicated by the evaluating.

92. The method according to claim 90 further wherein:
the operations are one or more selected from the group comprising of:
Fourier transformation (FT) of subportions;
FT of combinations of subportions;
FT analysis of one or more subdominant frequencies;
notch filter processed patterns;
cross correlation (CC) of subportions of the patterns including combinations of subportions;
CC adjusted by FT of subportions of the patterns including combinations of subportions.

93. The method according to claim 90 further comprising:
identifying an adjustment operation and subportion combination that provides a parameter or value or output used to adjust an adjusted operation and fringe subportion combination; and
configuring the detector to measure fringe shift using the adjustment operation and subportion combination to adjust an adjusted operation and fringe subportion combination.

94. The method according to claim 90 further wherein:
the two or more signal processing operations comprise a plurality of operation/fringe subportion combinations;
the comparatively evaluating comprises identifying at least one combination satisfying one or more statistical or chemical reaction criteria.

95. The method according to claim 90 further wherein when a plurality of combinations meet said criteria, selecting a combination in which at least one of said criteria is greater than criteria in another combination.

96. The method according to claim 95 further wherein when a plurality of combinations meet said criteria, selecting a combination by considering two or more criteria in combination.

97. The method according to claim 95 further wherein when a plurality of combinations meet said criteria, selecting a combination by considering two or more criteria according to a priority indicating which criteria is most important for said selecting.

98. The method according to claim 90 further wherein the patterns are fringe patterns from an interferometer and the sub-portions are one or more selected from the group consisting of:
individual fringes;
portions of fringes;
contiguous and non-contiguous sets of individual fringes and/or portions of fringes;
portions of fringe data defined by pixel-capture region, such as vertical and horizontal slices of the fringe data;
any combination of fringe data selected by one or more criteria in the frequency domain (e.g., via Fourier transform and/or frequency domain filtering);
results of any operation using any subportions, the operation being various mathematical or signal processing functions such as summing, filtering, weighted combinations, etc.

99. The method according to claim 90 further wherein the event is one or more events selected from the group consisting of: binding, protein folding, cleavage, unbinding, or any chemical or biological change in a sample or portions of a sample that causes a detectable back scattering interferometry (BSI) fringe shift.

100. The method according to claim 90 further wherein the event is one or more interaction events between moieties selected from the group consisting of: protein-protein, antibody-antigen, protein-small molecule or drug, protein-ion, protein-carbohydrate, protein-lipid, protein-nucleic acid, protein-DNA, protein-RNA, lipid-lipid, DNA hybridization, DNA-RNA binding, binding to molecular mimetics such as molecular imprints (MIP); binding to membrane bound proteins, binding to biomolecules immobilized or associated with nanoparticles, binding to biomolecules or molecules embedded in cell membrane-like structures or mimetics (lipoparticles, liposomes, unilamellar vessicels of varying size, nanodiscs).

101. The method according to claim 90 further comprising any combination of any of the elements of claims 91 to 100.

102. A method for detecting an event from a change between at least two interferometric fringe patterns comprising analyzing sub-portions of at least two patterns by performing an FT analysis of said fringes and using primarily changes in one or more non-dominant spatial frequencies to detect an event and communicating occurrence of the event to a user.
